(19) United States
(12) Patent Application Publication
(10) Pub. No.: US 2002/0127088 A1
(43) Pub. Date: Sep. 12, 2002

(54) Hand truck / forklift apparatus

(76) Inventor: George Sharpton, Smyrna, GA (US)

Correspondence Address: George Sharpton, 4585-B Valley Parkway S.E., Smyrna, GA, 30082, US

(21) Appl. No.: 09/788,019

(22) Filed: Feb. 20, 2001

(51) Int. Cl. B66F 1/00

(52) U.S. Cl. 414/664

(57) ABSTRACT

The hand truck/forklift as disclosed in this application is new and useful as an improvement of the conventional hand truck in that it enables lifting of loads up to four feet high as-well-as transporting loads commonly carried on a conventional hand truck. This lever operated lift is also an improvement in that it enables lifting of heavy loads by a person without the use of more expensive power operated lifts where space and environmental concerns make them impractical to operate. This lever operated lift enables the operator to lift heavy loads safely equaling the lifters body weight plus his lift strength while keeping his back in an up-right posture. The lever lift assembly is also new and useful in that it allows the operator to lift a load and allows that load to be held at a selected height by use of a sleeved punched post frame assembly with spring loaded set pins which are manually retracted by use of hand operated cable from the lever side of the lift. The power operated lift as disclosed in this application is new and useful as an improvement in a forklift assembly in-that-it provides a means of extending the reach of a lift mass by means of a boxed rotary frame attached at fixed points on a fixed or extendable lift mass assembly by use of chains with cogwheels and hydraulic jack assemblies as illustrated in attached drawings. This invention in either form can also be used as a supplement to conventional hand trucks and forklifts by transporting and lifting loads onto and from hand trucks to work counters, trucks etc. and loading pallets for heavier conventional lifts for improved efficiency in material handling.

### CROSS REFERENCES TO RELATED APPLICATIONS

| International Claims: | |
|---|---|
| B65G 67/04 | B66F 9/10 |
| B66B 9/20 | B66F 9/14 |
| B66F 9/6 | E04G 1/22 |
| E06C 7/12 | E04G 1/22 |
| United States Claims: | |
| 1,991,576 | |
| 2,582,999 | |
| 2,621,817 | |
| 2,904,201 | 4,015,686 |
| 2,904,203 | 4,051,970 |
| 2,940,625 | 4,131,181 |
| 3,344,890 | 4,261,438 |
| 2,833,003 | 4,458,786 |
| 3,394,778 | 4,546,853 |
| 3,501,034 | 4,506,764 |
| 3,709,393 | 4,987,976 |
| 3,876,039 | 4,797,055 |
| 3,934,681 | |
| 3,957,137 | |
| 3,841,442 | |

2 General Claims (3 sub claims)/33 Drawing Figures

### BACKGROUND OF INVENTION

A mobile load handling, retractable, extensible mast with an attached rotary mast which was discovered as a result of designing a means of lifting an assembly of hinge connected floor-to wall-to roof panels for an improvement in U.S. Pat. No. 3,857,211 is further improved for use as either a forklift or hand truck/lift assembly or combination thereof. This versatile lift assembly is also improved by use of extensible masts to which the rotary mast as described herein is attached. The rotary mast as described in this specification is capable of being attached to mast of numerous types by use of metal plates and brackets as described herein.

### SUMMARY OF INVENTION

This lift is further improved with the attachment of forklift tongue and other attachments as described herein. This forklift which includes an extensible assembly of three channel frame assemblies interconnected at vertical channels by trolleys and a pivotally attached rotary mast so-as-to facilitate vertical lifting by means of a series of chain assemblies which are optionally controlled by means of a series of hydraulic jacks and or manually operated levers. This lift is designed for both manual and power operated lifting of various light industrial, commercial, light utility, freight, retail deliveries, automotive shop, approved ambulatory and household appliances loads.

The lifting capacity of the manually operated hand truck/lift assembly is limited directly to the body weight of the operator, and the power operated lift assembly is only limited by design of the hydraulic jack system and the size and metal type of the base and mast frames and their various attached components. The limit of the raised unattended load on the lift fork when supported by the by the sleeved post prop assembly is determined by the size of the counter weight(s) positioned on the base frame of the lift on the opposite side of the rotary mast frame. However, the operator is capable of lifting a weight equal to the operator's weight plus the weight which the operator is capable of lifting from a bent knee position with his back in a vertically upright posture to a vertically straight legged upright posture. The full rotary height of the load on the rotary lift mast can be achieved by successively stepping on the rotating foot bars on the lever side and exerting knee lift pressure while the operators hands are griped to the handles at the end of the lift chain prop assembly on the lever side of the lift. Therefore the size of lift frame posts, chains and the various component assemblies must be designed to lift loads by an operator having the highest combination of both body weight and lift strength, or specific lifts must be designed with load lift limits. Offsetting counter weights must also be sized accordingly.

The load on the power operated lift is leveraged by the counter weight(s) on the operators side of the lift, and the lift load is limited not to exceed the counter weight which excludes the body weight of the operator and other temporary loads on that side when the rotary frame is rotated to its horizontal position. The maximum load on the rotary lift is greatest when the load on the fork is rotated such that the pivotal frame of the rotary mast frame is in its it's extreme horizontal position. The lever of the manually operated fork lift/ hand truck is correspondingly set to align in a horizontal plane with the rotary mast for the greatest leverage. The maximum lift height of the load on the manually operated lift is typically 4 feet. However, this height can be greater if the length of the rotary mast is longer.

The manually operated version of this lift as illustrated in FIG. 3 is can be converted to a power operated system as illustrated in FIG. 2 when an extended height front base frame is used by removing the rear mounted lever assembly and its associated parts and adding a series of power operated jacks as described here-in. The post-prop and sleeve assembly is also detached when the power operated jacks are used to lift the rotary frame. A motor is placed on the base panel between the front and rear ‘A’ frame channel posts to drive the hydraulic system.

Attached to the third (outermost) frame assembly is a cubical rotary frame assembly with a forklift tongue assembly which is lifted simultaneously with the sectional mast to which this rotary frame is attached. This rotary mast is capable of being lifted by means of either a pair of directly attached hydraulic jacks, a series of chain and cogwheel assemblies operated by means of hydraulic jacks, electrically operated sleeved auger jacks or a chain and cogwheel assembly manually controlled by use of levers. The rotary lift mast is supported at its outer rotary end by use of a sleeved and punched channel assembly on casters which is pin locked at selected heights to hold the forklift tongue at fixed positions.

When the extensible mast is used the cogwheels and chains of the assembly are arranged so-as-to be vertically off-set with fixed center wheels such that when the two outer cogwheel/chain assemblies bypass the center wheel there is take-up in the chain length thereby proportionately increasing the off-set caused by the extension of the hydraulic jack to add to the lift height of the carriage attached to the outer mast or the rotary mast when the rotary mast is attached.

The base frame assembly for this forklift/hand truck is retractable on an interlocking trolley channel track assembly. The bilateral chain assembly is balanced by axle connected cogwheel assemblies attached to the base frame and to the extensible masts of the forklift/hand truck assemblies.

The base frames channels of this lift assembly are of a standard size, but may vary in metals made of aluminum, metal alloys or stainless steel for unit weight and lift strength design variations. These channel frames may be doubled back-to-back for added strength. Larger channels, chains, wheels and trolleys would also be used for units of higher lift capacity.

### DESCRIPTION OF DRAWINGS

FIG. 1 illustrates the combined assembly of the features of the power operated lift assembly as illustrated in FIG. 2 and the manually operated hand truck/lift assembly as illustrated in FIG. 3. This combined assembly would only be necessary to lift moderate loads to low heights only if the power operated assembly was inoperable because of a power failure, lack of fuel, hydraulic jack system failure or other problems associated with a power operated lift system with an electric motor or gas driven engine or a combination thereof. The ‘A’ frame channel and the rotary mast and fork assemblies are common to both the power and manually operated system but the lift chain and cogwheel assemblies are different as illustrated in the various drawing associated with the two distinct operating systems. This figure illustrates the features of the motorized assembly of hydraulic jacks, stirring, brake and accelerator assemblies as illustrated along with a seat, counter weights and a protective overhead grille on an extended chassis. The motor housing is illustrated in FIG. 2 for clarity.

FIG. 2 illustrates the three dimensional view of the lift assembly in the power operated mode with front and rear hydraulic jacks, a vertically extensible mast, a rotary mast with lift fork which is tilted about the rotary frame by means of specially attached hydraulic jacks all of which are supported directly or indirectly by an ‘A’ frame assembly which is supported by a casters and channel track mounted trolley wheels with the track resting on a plywood panel which is supported at both ends by cross member with swivel wheel casters attached to one or both ends. This figure further illustrates a front centrally mounted hydraulic jack which operates a series of cogwheels mounted to the offsetting extensible mast and the fixed ‘A’ frame with chains which terminate at points on both the front of the ‘A’ frame and the base of the extensible mast. This figure also features a combination of rear mounted hydraulic jacks which are used to offset upper and lower rear mounted cogwheel assemblies with chains which terminate at the points on both the rear ‘A’ frame and the base of the lift fork at the lower outer pivotal connection of the rotary mast frame assemblies. This figure also illustrates a chain prop frame assembly on both side of the rotary lift frame. The operation of this assembly is described in the next section which is called Description of lifting methods, parts and component assemblies.

FIG. 3 illustrates the three dimensional view of the lift assembly in the manually operated mode with lever handles to operate the rotary frame by means of chain and cogwheel assemblies about a mobile centrally positioned ‘A’ frame assembly which functions as a fulcrum in this lever operated lift assembly. This figure also features front and rear mounted chain prop frame assemblies mounted on both sides of the rotary lift mast and the lever operating assemblies respectively. This drawing also illustrates a counter weight located on the central base of the connecting ‘A’ frame panel which is used to leverage loads on the list fork supported by the sleeved post prop assembly in the absence of the operators body weight. See elevations and sectional views as referenced.

FIG. 4 illustrates the plan view of the power operated assembly as described in FIG. 1 above at the base level as indicated on the section and elevation views of these drawings.

FIG. 5 illustrates the plan view of the power operated assembly as described in FIGS. 1 and 2 above at mid level as indicated on section and elevation views of these drawings.

FIG. 6 Illustrates the plan view of the power operated assembly as described in FIGS. 1 and 2 above at the upper level as indicated on the section and elevation views of these drawings.

FIG. 7 illustrates the plan view of the basic lower frame of the manually operated hand track/lift assembly.

FIG. 8 illustrates the plan view of the lower section of the manually operated hand truck/lift assembly on a removable swivel wheeled platform as described in FIG. 3 above.

FIG. 9 illustrates the plan view of the upper section of the manually operated hand truck/lift assembly as described in FIG. 3 above.

FIG. 10 illustrates the side view elevation of the power operated forklift assembly as described in FIGS. 1 and 2 above.

FIG. 11 illustrates a sectional view at the longitudinal center of the power operated forklift assembly as described in FIGS. 1 and 2 above.

FIG. 12 illustrates a sectional view at the lift chain/cogwheel assembly plane of the power operated forklift assembly as described in FIGS. 1 and 2 above.

FIG. 13 illustrates the sectional elevation view of the rear of the power operated forklift assembly as described in FIGS. 1 and 2 above cutting through base panel at the brake and accelerator assemblies.

FIG. 14 illustrates a view of the extreme rear view of the power operated assembly showing the elevation of the rear wheel and steering assembly connections as illustrated in FIGS. 1 and 4 above.

FIG. 15 illustrates a cross sectional view of the power operated assembly as described in FIG. 2 above at the center of the ‘A’ frame with offsets to pick up trolley wheel positions in the channel post frame members as well as the mounting connections of the lift frame components in that view.

FIG. 16 illustrates the frontal view of the power operated fork lift assembly as described in FIG. 2 above.

FIG. 17 illustrates the frontal view of the manually operated hand truck/lift assembly on a swivel wheeled platform as described in FIG. 3 above.

FIG. 18 illustrates the rear view of the manually operated hand truck/lift assembly as described in FIG. 3 above.

FIG. 19 illustrates the side view of the manually operated hand truck/lift assembly as described in FIG. 3 above.

FIG. 20 illustrates a sectional view of the basic manually operated hand truck/lift assembly at the extreme downward rotation of the rotary mast frame with axle mounted wheels and rear mounted wheels mounted to the base frame of the a frame assembly with load fork in the upright position.

FIG. 21 illustrates a sectional view of the basic manually operated hand truck/lift assembly as described in FIG. 20 above with the load in a tilted position to ease transport by concentrating the center of gravity of weight toward the front wheels of the unit. The rear swivel wheel assembly is adjustable about a tubular slotted sleeved assembly with removable pins for pivotal tilting of the load. This figure also illustrates the levers and the chain prop assemblies in their folded positions to reduce the length of the hand truck/lift assembly movement through tight areas and to require less space for storage of unit with or without a load.

FIG. 22 an enlarged illustration of a plan area view of the tilt jack as referenced in FIG. 6.

FIG. 23 an enlarged illustration of a plan area view of the mast frame assembly as illustrated in FIG. 5.

FIG. 24 an enlarged illustration of a sectional area view of the lower mast and lift chain assembly as referenced in FIG. 12.

FIG. 25 an enlarged illustration of a sectional area view of the upper mast and lift chain assembly as referenced in FIG. 12.

FIG. 26 an enlarged illustration of a sectional area view of the extended mast and lift chain assembly as referenced in FIG. 12.

FIG. 27 an enlarged illustration of a sectional area view of the upper central mast frame and jack assembly as referenced in FIG. 11.

FIG. 28 an enlarged illustration of a sectional area view of the mid central mast frame and jack assembly as referenced in FIG. 11.

FIG. 29 an enlarged illustration of a sectional area view of the lower central mast and jack assembly as illustrated in FIG. 11.

FIG. 30 an enlarged illustration of a cross-sectional area view of the lower base, mast frame, wheel, drive chain and jack assembly as referenced FIG. 13.

FIG. 31 an enlarged illustration of a cross-sectional area view of the central mast, lift chain and jack assembly as illustrated in FIG. 13.

FIG. 32 an enlarged illustration of an area elevation of the lever handle and foot plate assembly in the lower rotated position as referenced in FIG. 18.

FIG. 33 a detailed sectional view of the lever arm assembly as referenced in FIGS. 19 and 20.

### DISCRIPTION OF LIFTING METHODS, PARTS AND COMPONENT ASSEMBLIES

The lift is positioned to receive a load on fork 68 which is directly attached to a tubular sleeved support post assembly which is attached to a rotary mast which is either attached to a vertically extensible mast 51 when used with a system of power operated hydraulic jacks, or directly to the front posts of the A-frame base assembly by means of mounting brackets when assembled for manual operation by use of levers.

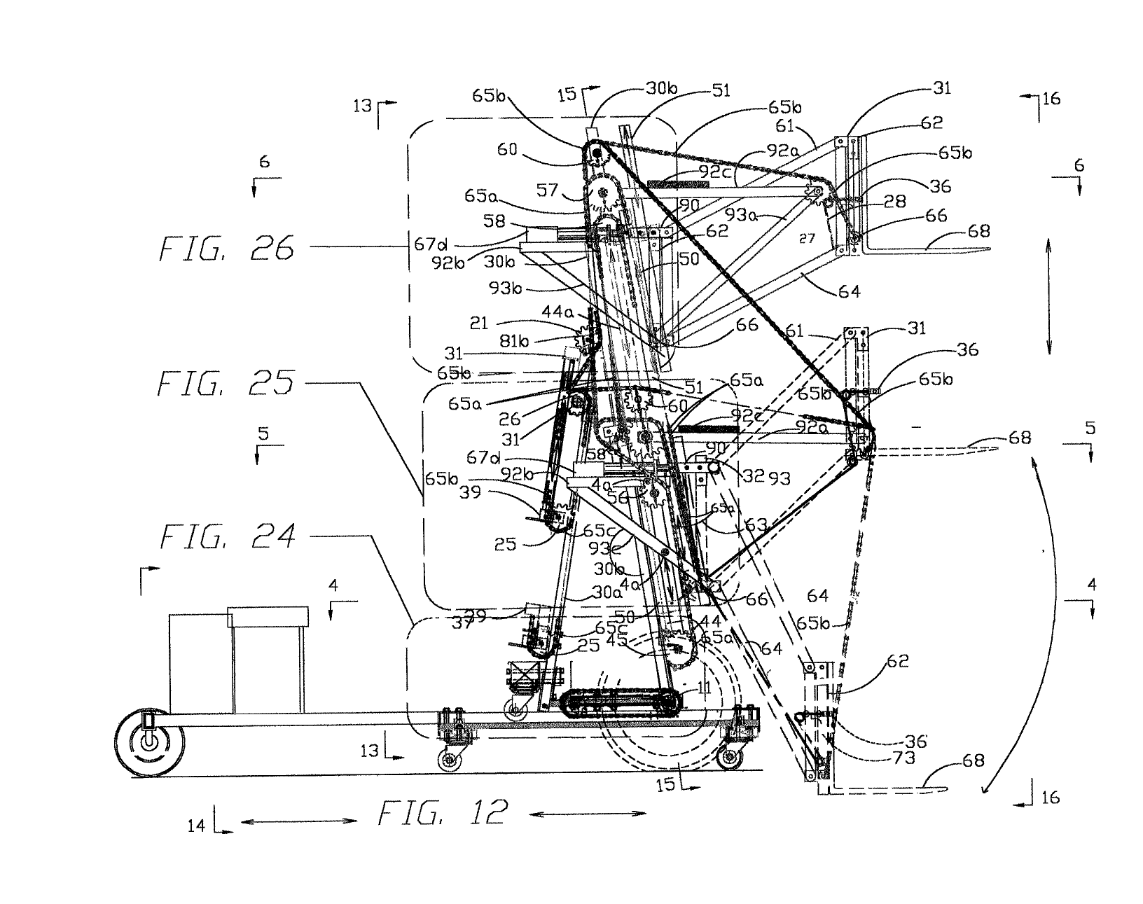

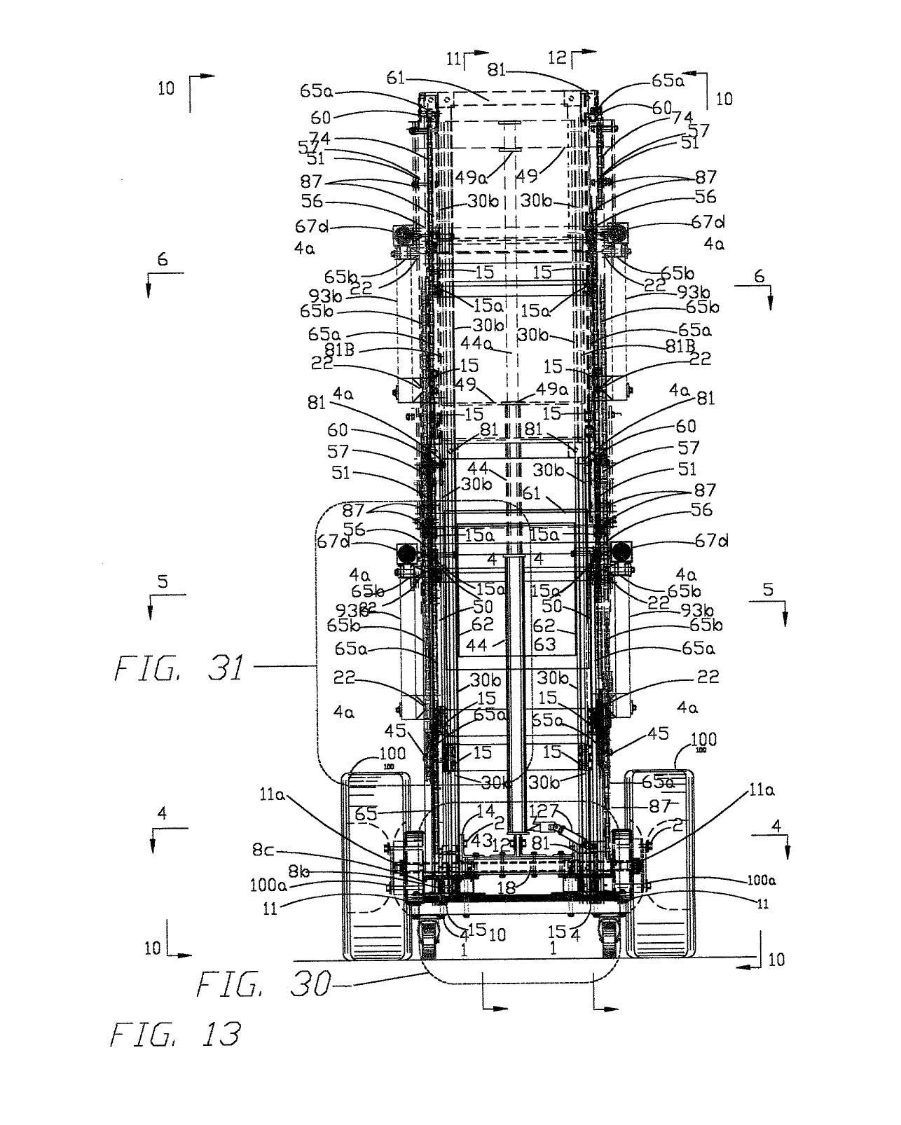

Lift is moved forward toward load until fork tongue 68 is beneath load. A hydraulic jack 44 is then powered to lift cogwheel assembly no. 46 which is offset vertically along base mast lift chains 65a starting at a fixed cogwheel 31, or a power operated cogwheel wheel 75 which is used to wind the base lift chain 65a if hydraulic jack 67b is not used to lift the base mast as described above. The power-operated cogwheel 75 rotates with a circumference equal to the length of the stroke of hydraulic jack 67b as illustrated in FIG. 12.

When cogwheel 46 is offset by use of jack 67b the take-up in base lift chain 65a is twice the stroke of the jack as illustrated in FIG. 12.

The vertically extending mast 51 is lifted by means of the extended mast chain 65a which is run across the top of wheel 56 which rotates on an axle fixed to vertical extending mast 30b. Chain 65a runs from there beneath cogwheel 58 which rotates on an axle fixed to the upper frame assembly, and from there across wheel 57 on an axle atop extending mast 50 and down to base of secondary mast 51 to hook 66 as illustrated in FIG. 12.

As the primary extending mast 50 is lifted the extended mast chain 65a is offset about wheels 56, 58 and 57. This offset in extended mast chain 65a is twice that of the stroke of the hydraulic jack 44 which facilitates the offset in this lift stage as illustrated in FIGS. 11 & 12. The take-up in base-lift chain 65a lifts the secondary mast 51 to the full height equal to the take-up in the extended mast cable 65a when lifting occurs.

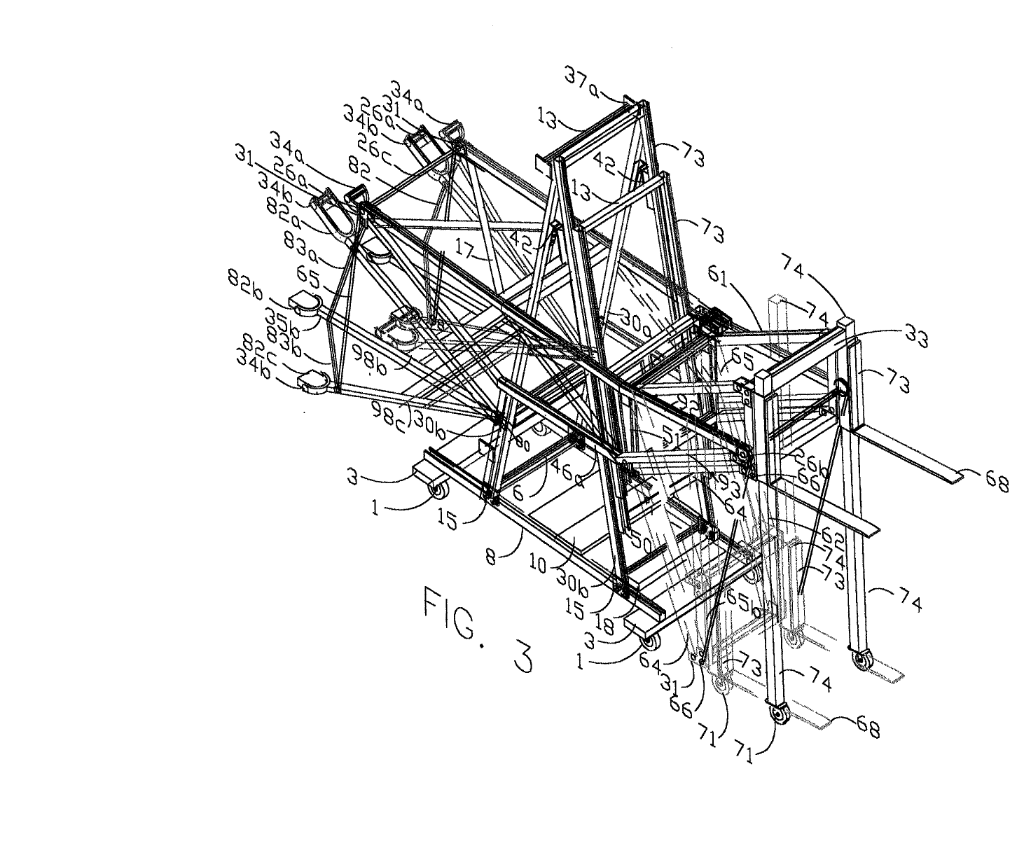

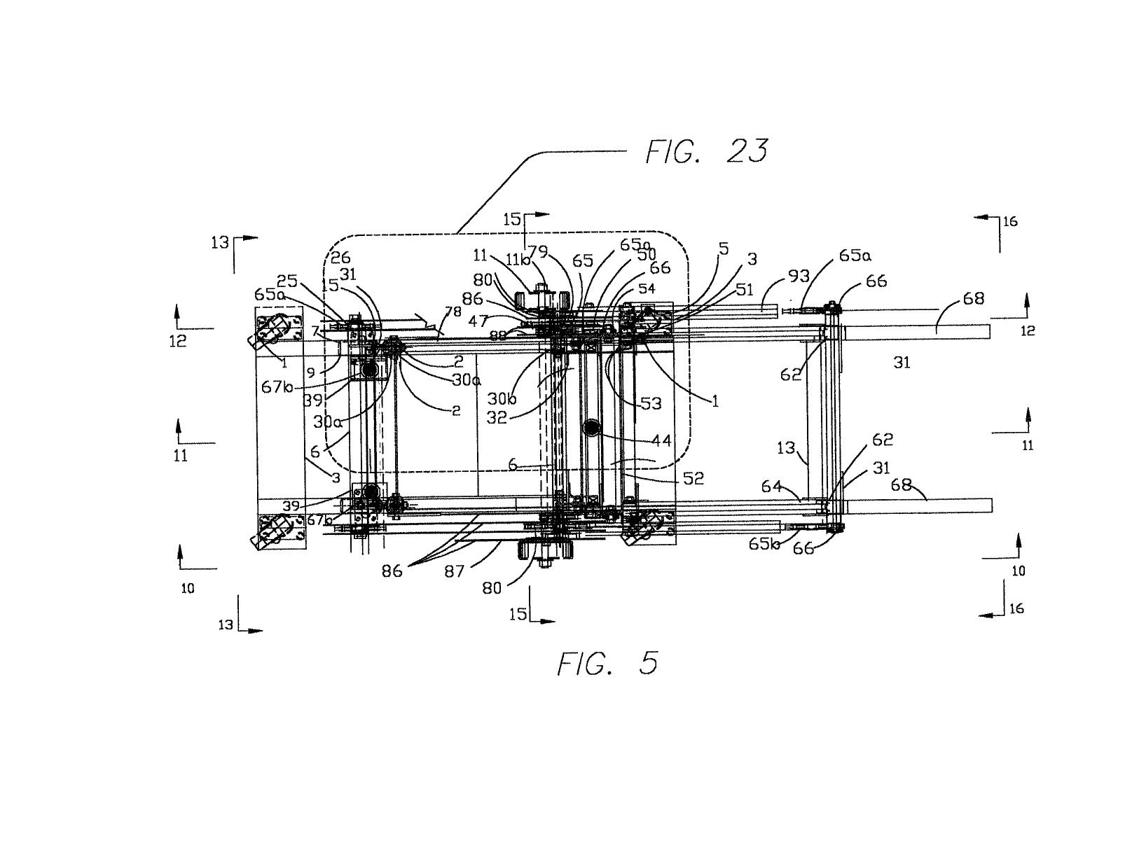

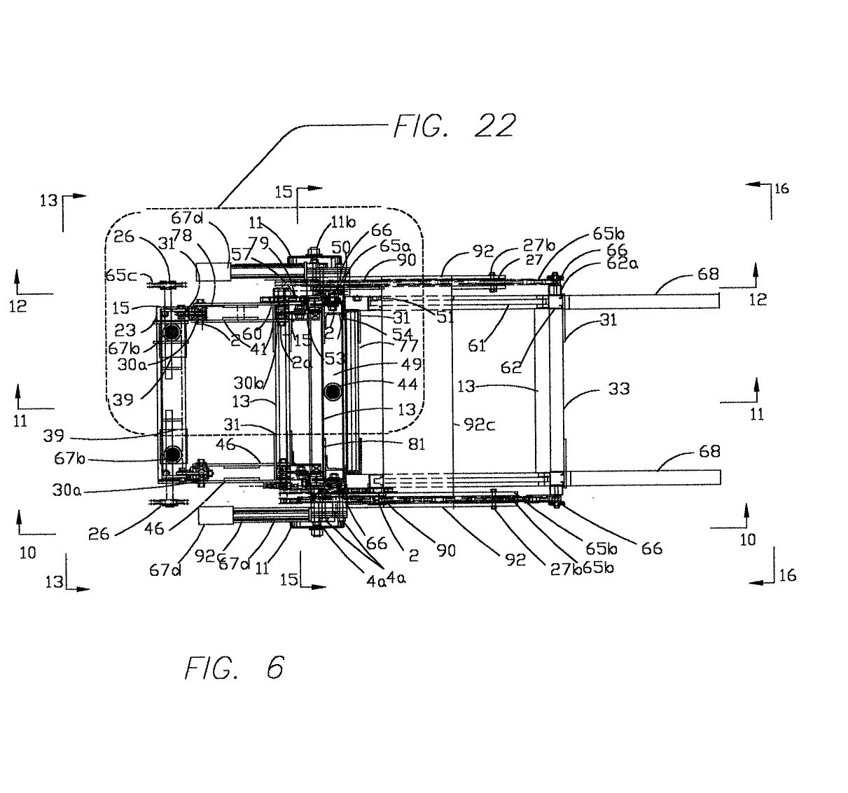

Separate rotation of rotary lift mast 62 is facilitated by a choice of two separate means by use of either manual rotation of bilateral levers 35 (FIGS. 3, 19, 20 and 21) to which a pair of chains 65 is attached, or the take-up in extended mast chain 65b by means of hydraulic jacks 67c (FIGS. 5, 6, 11 and 16 which are used to offset cogwheel 25 which moves vertically about rear base frame 30a alternately toward and away from cogwheel 26 as illustrated in FIG. 12.

The extension of 67b results in the rotary mast assembly being lifted vertically along mast 51. The series of interconnecting masts would move vertically past one another by means of interlocking trolleys as lifting occurs as illustrated in FIG. 11.

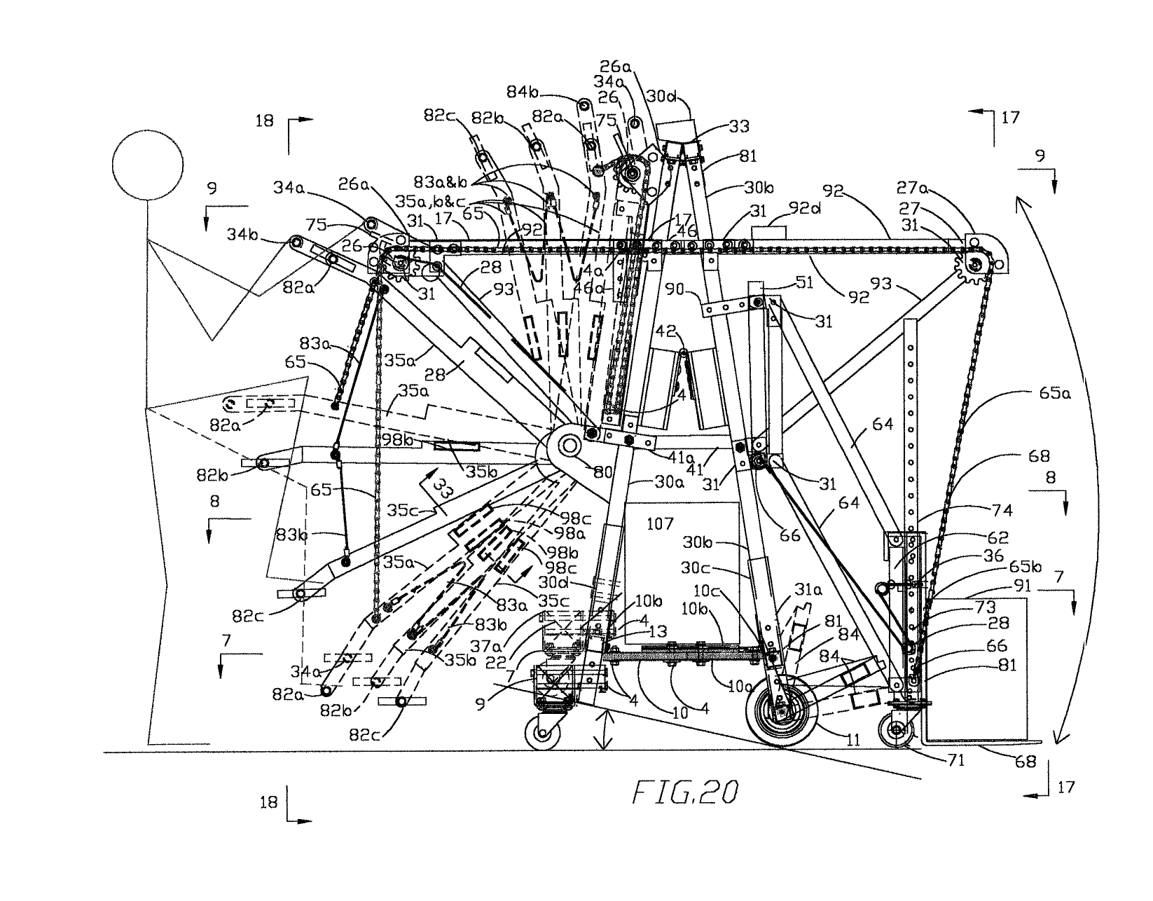

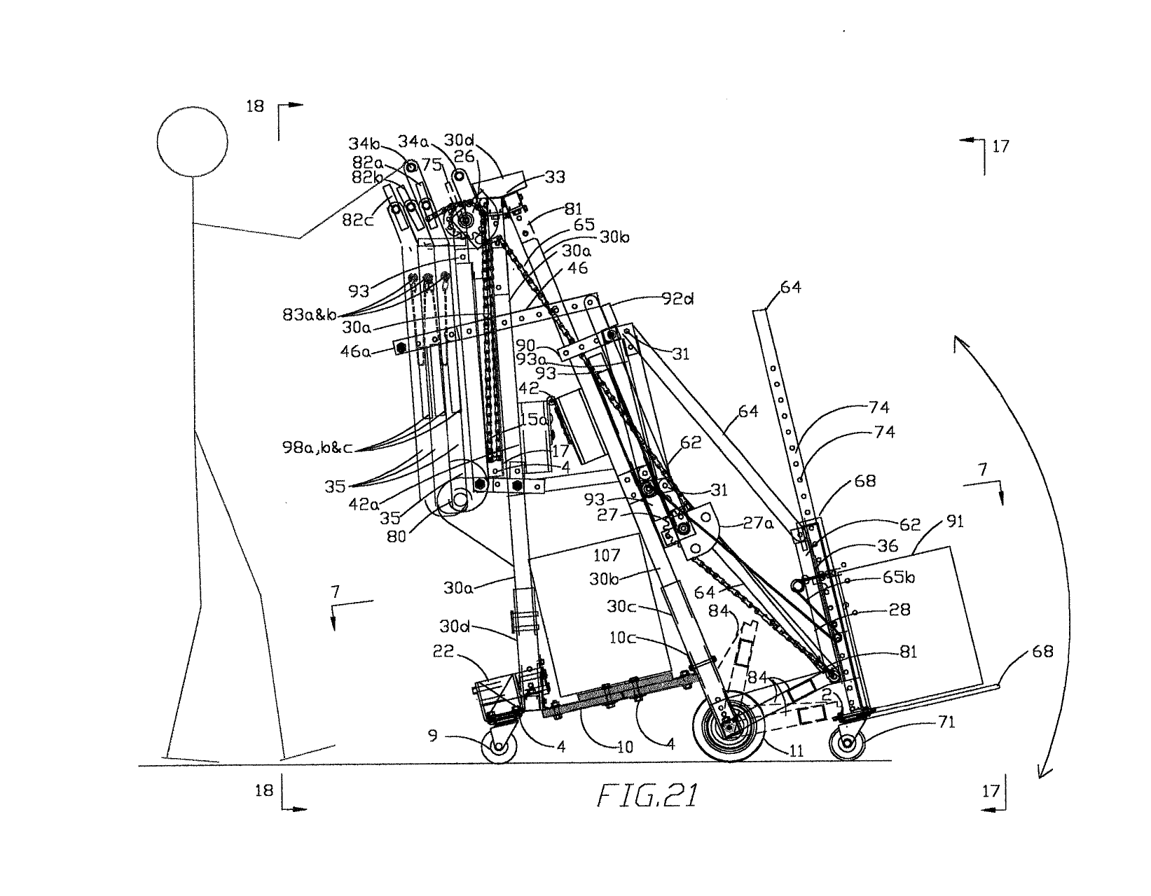

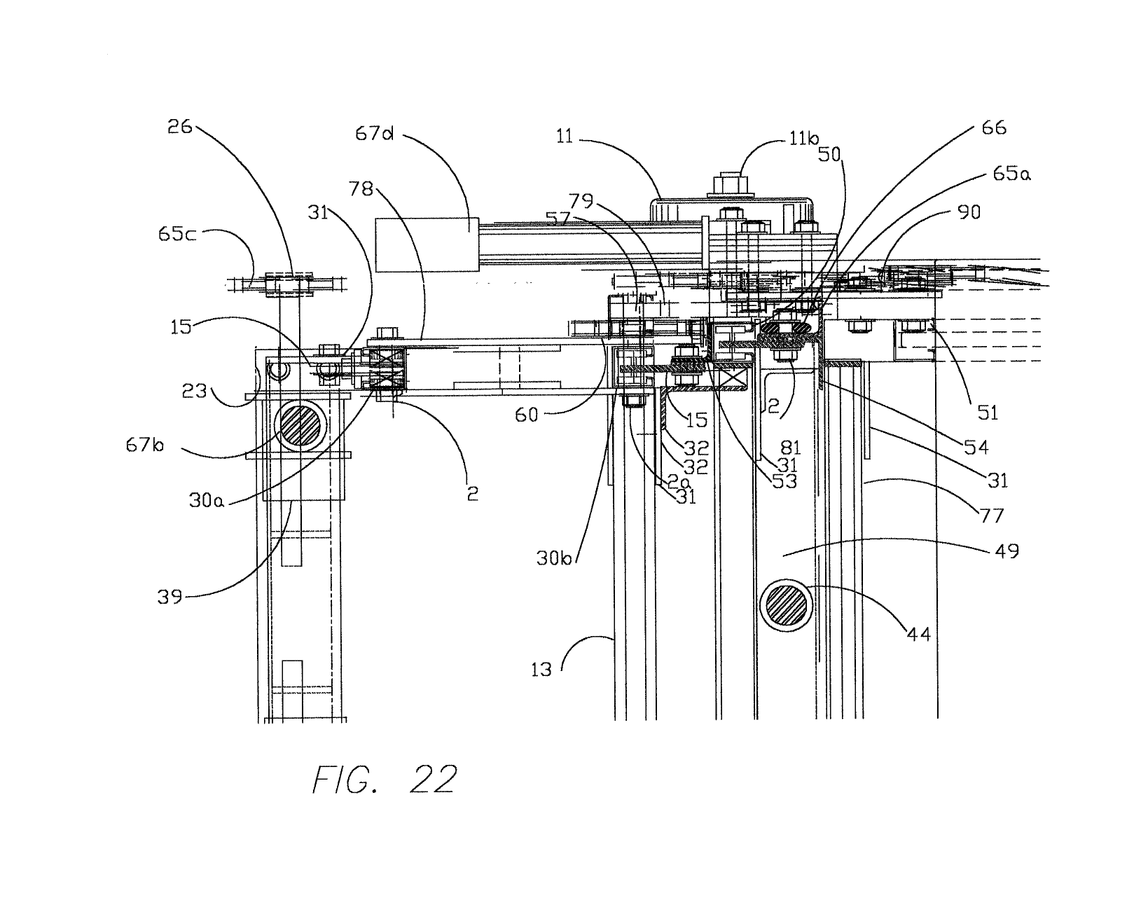

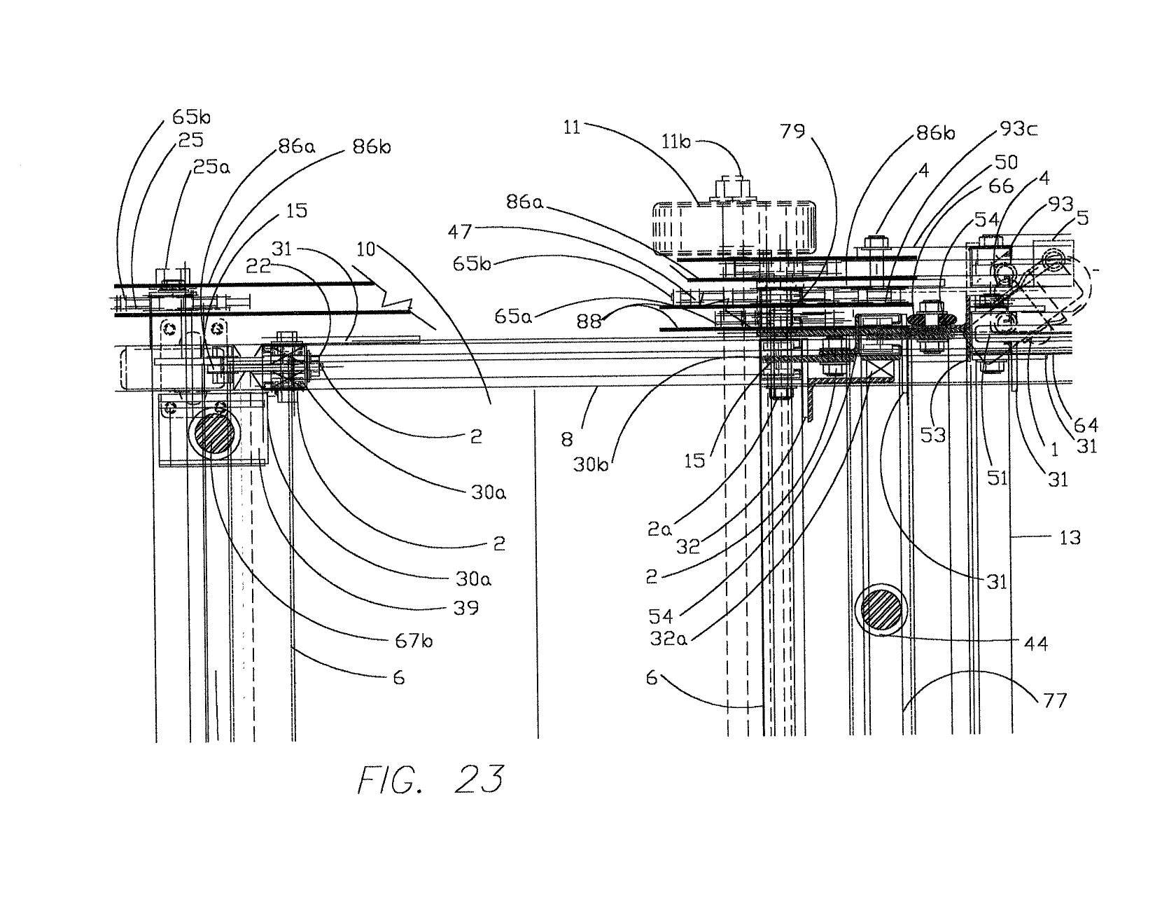

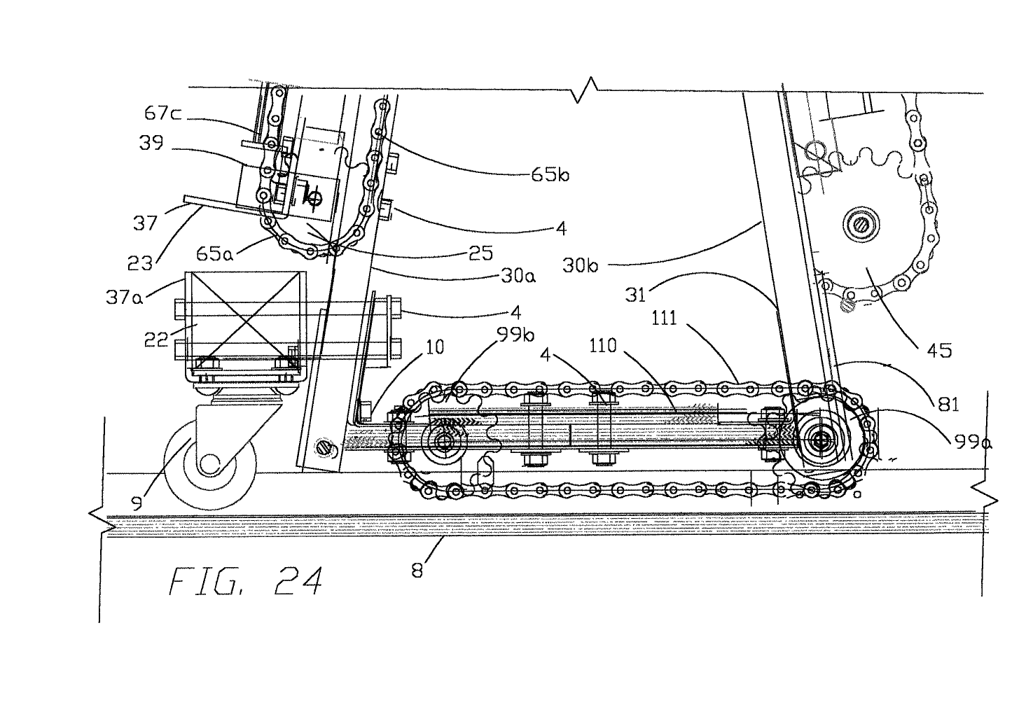

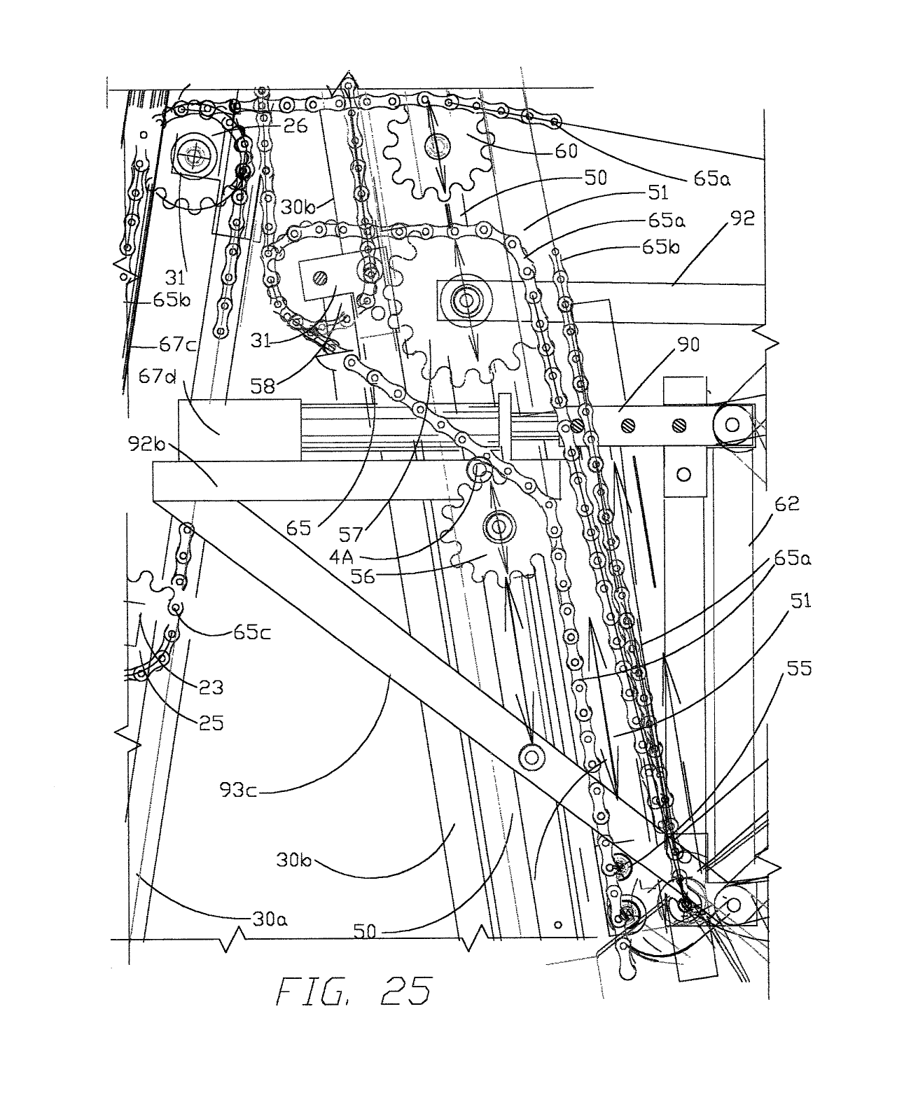

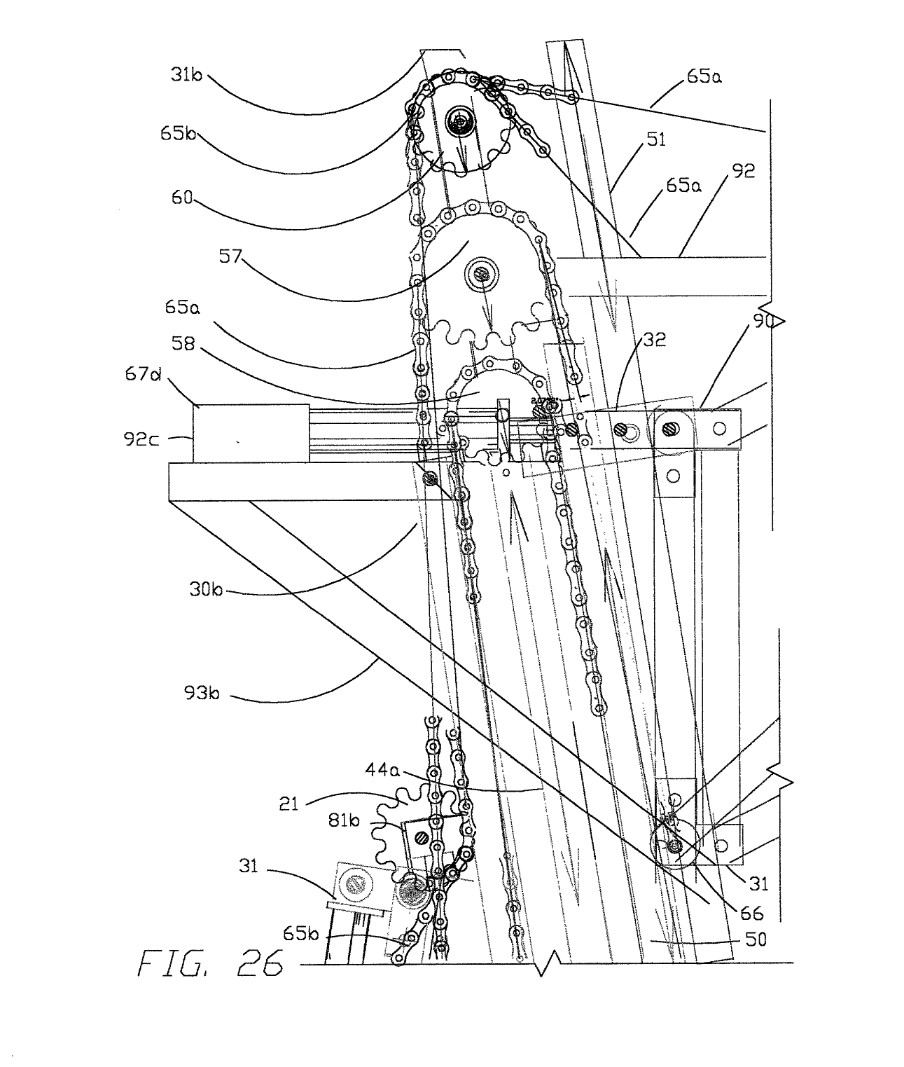

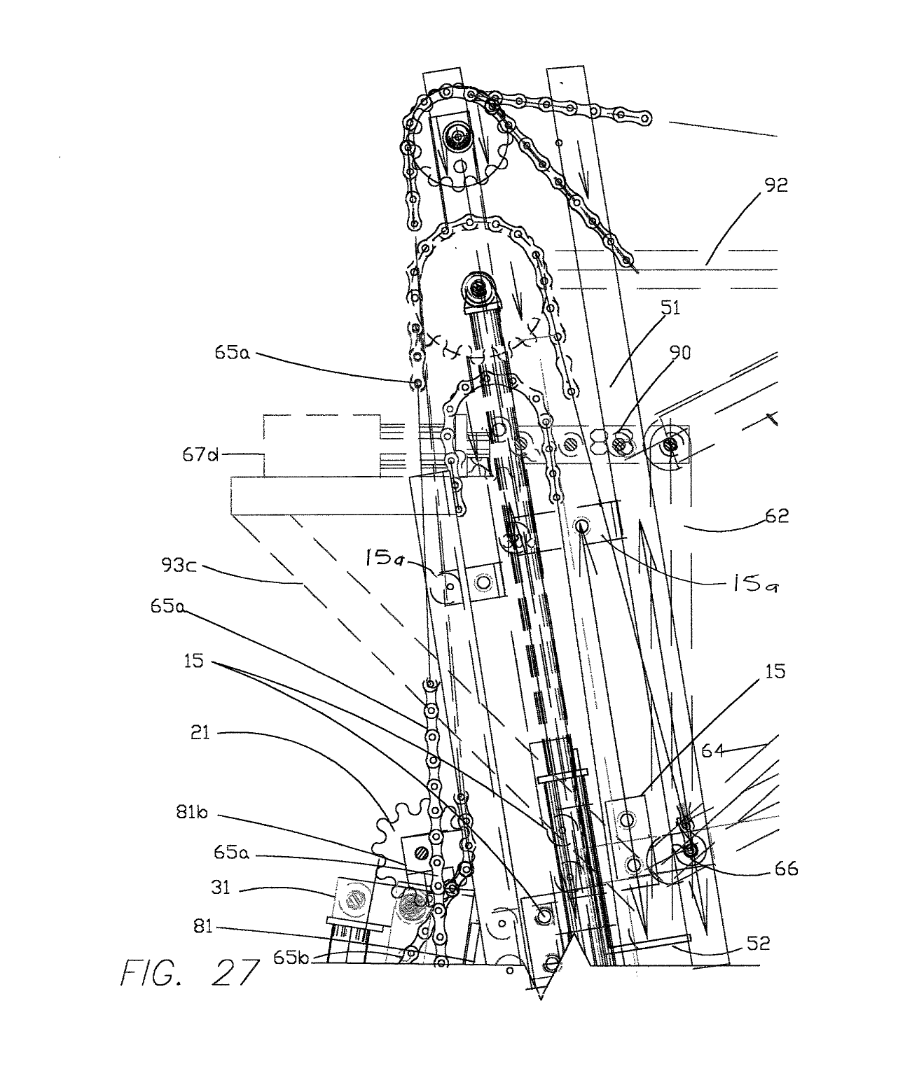

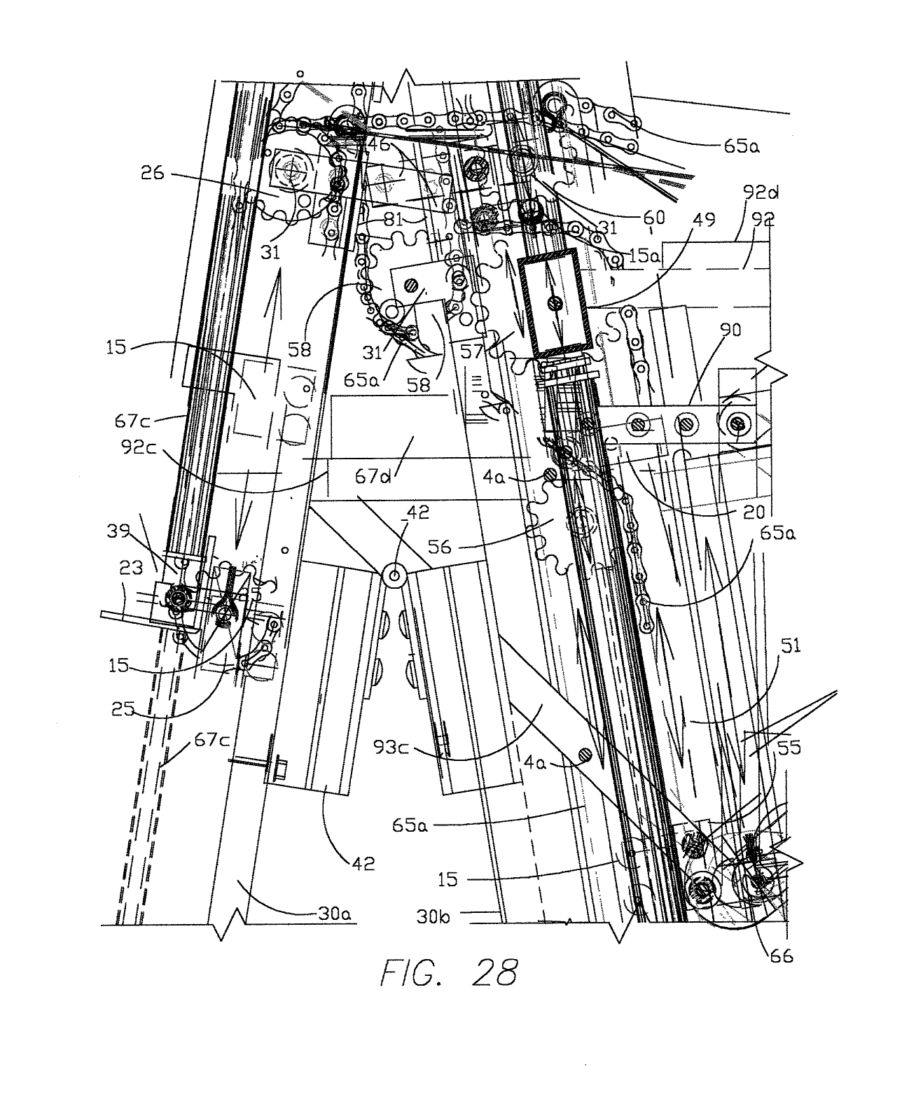

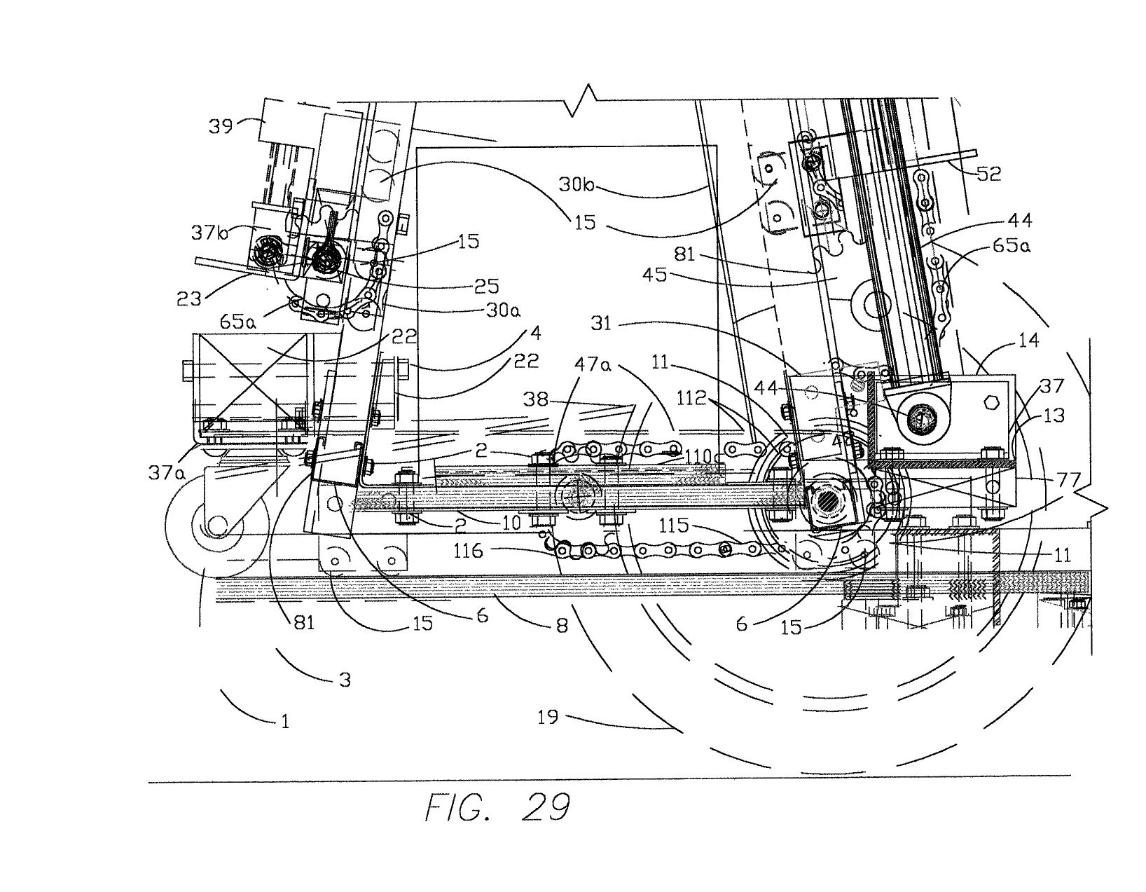

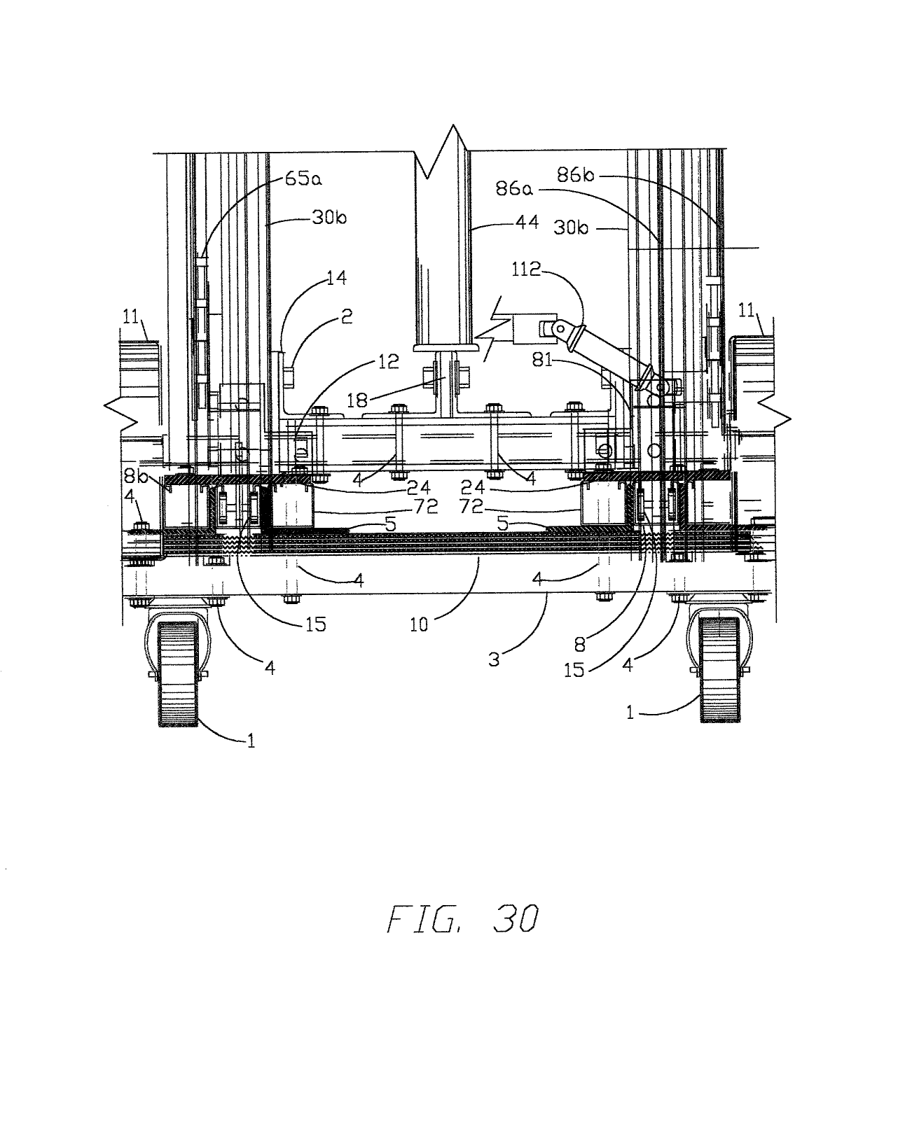

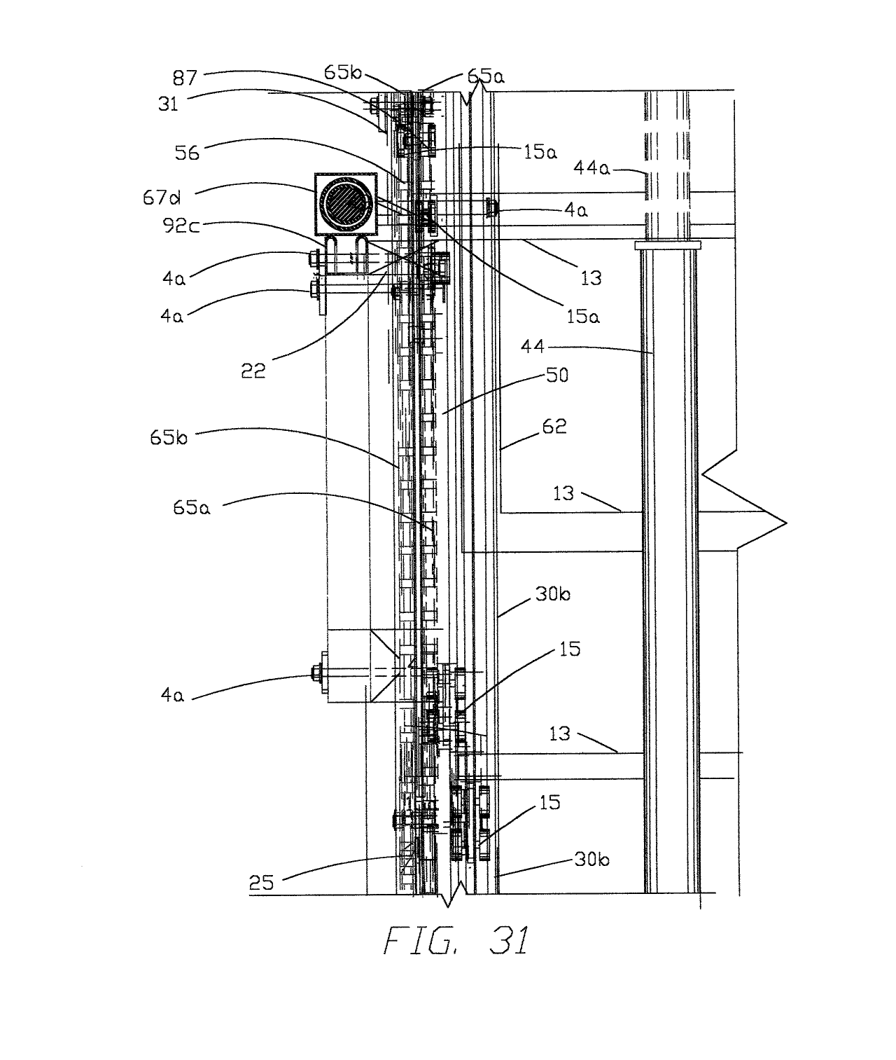

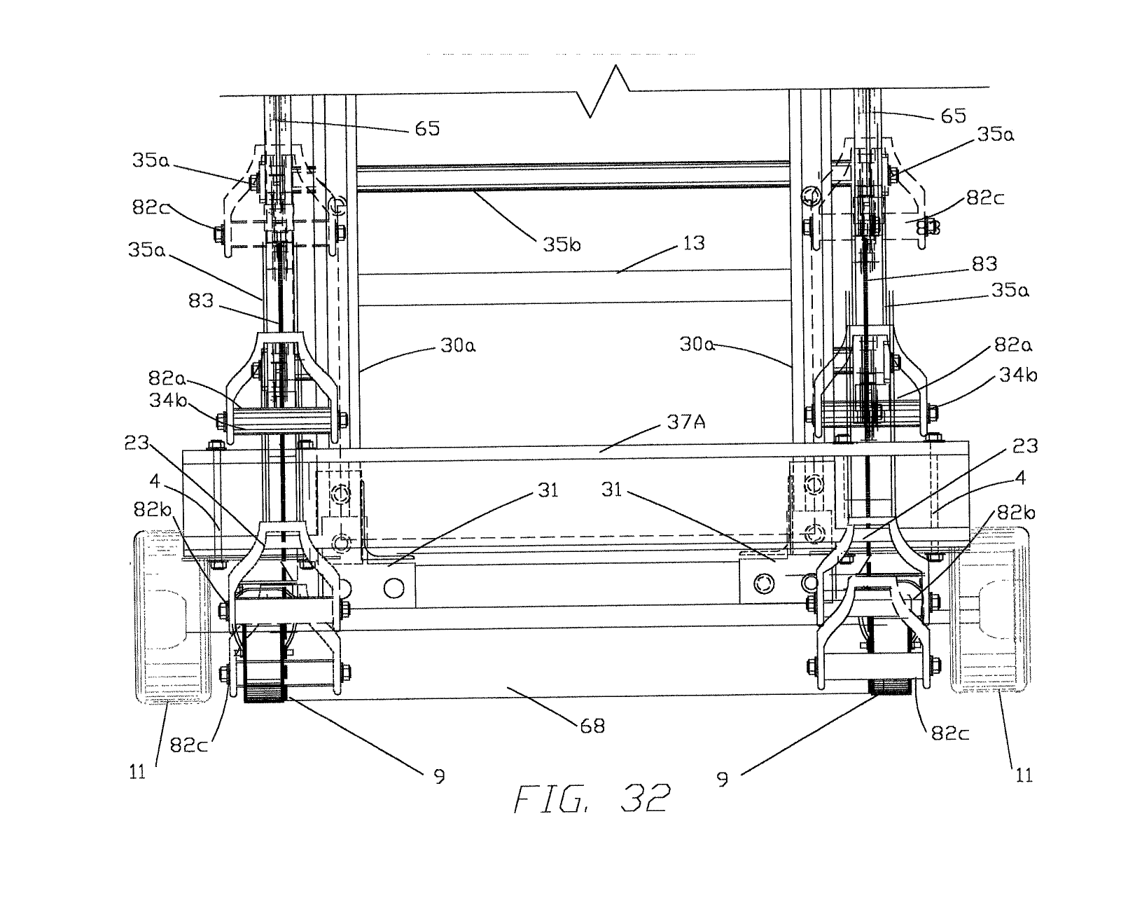

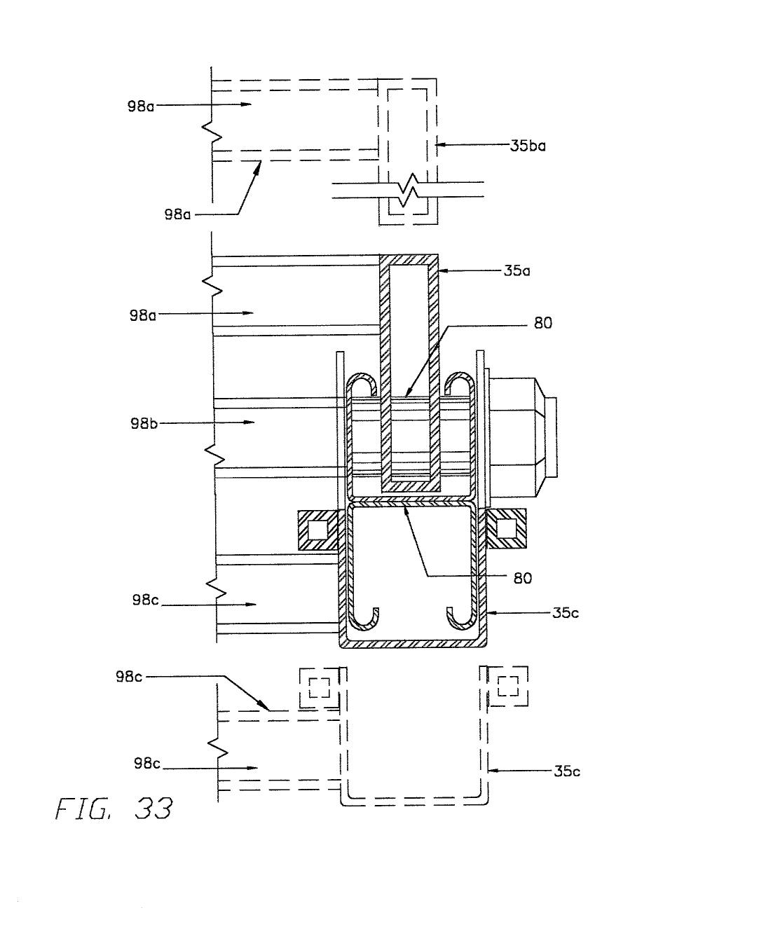

The multiple hand and foot operated levers and the chain prop assemblies are folded into vertical position so-as-to assume less space when moving and turning in tight spaces, or when stored as illustrated in FIGS. 20 and 21. L-shaped pins are inserted in the outermost holes on the rotary segments of bar 46 to hold the levers and mast prop assemblies in the folded position about the base frame of the lift.

When the manually operated levers 35 are rotated using chain assembly 65 about cogwheels 26 and 27 on chain prop frame 92/93 the load fork 68 is lifted accordingly. The lowering of lever handles 34 is achieved by stepping on foot pedal 82 which is suspended from lever 35 at handle 34 by means of an adjustably flexible cable 83 and buttressed by channel 98a, and vice-versa for lowering the foot pedal.

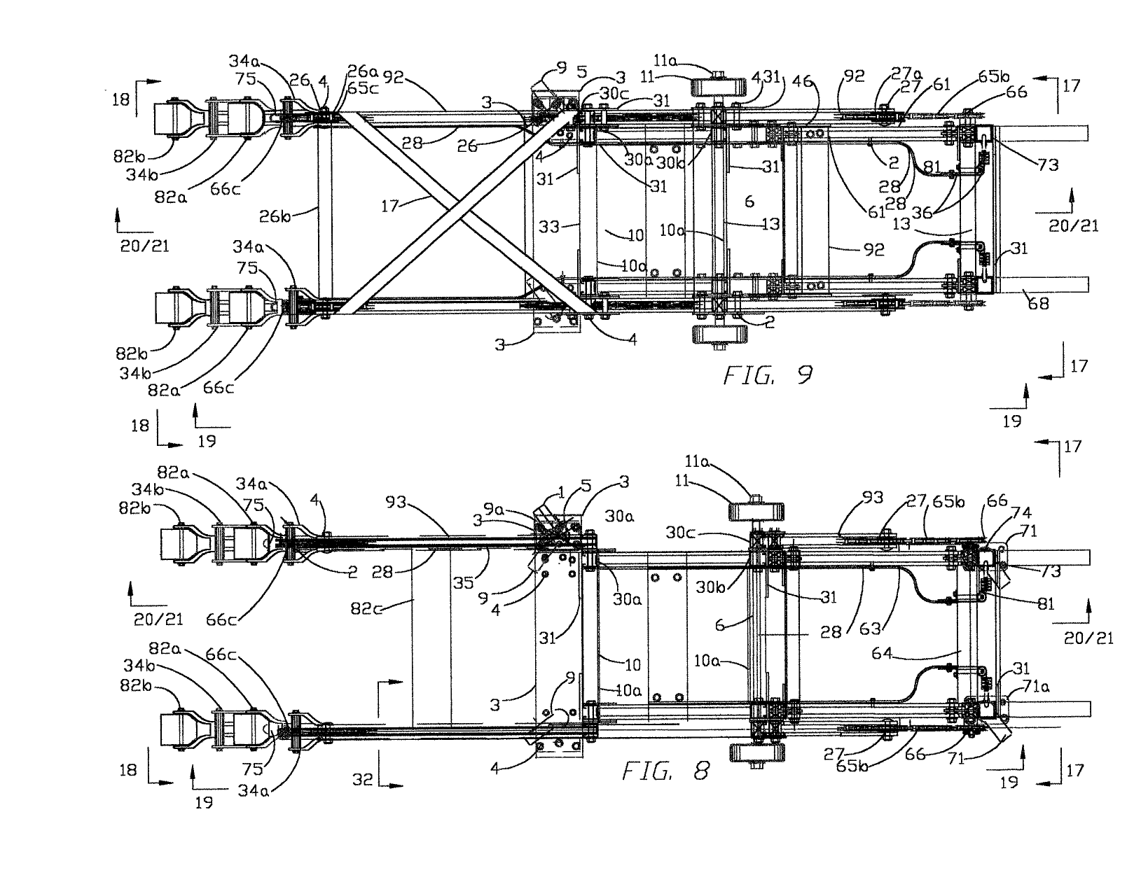

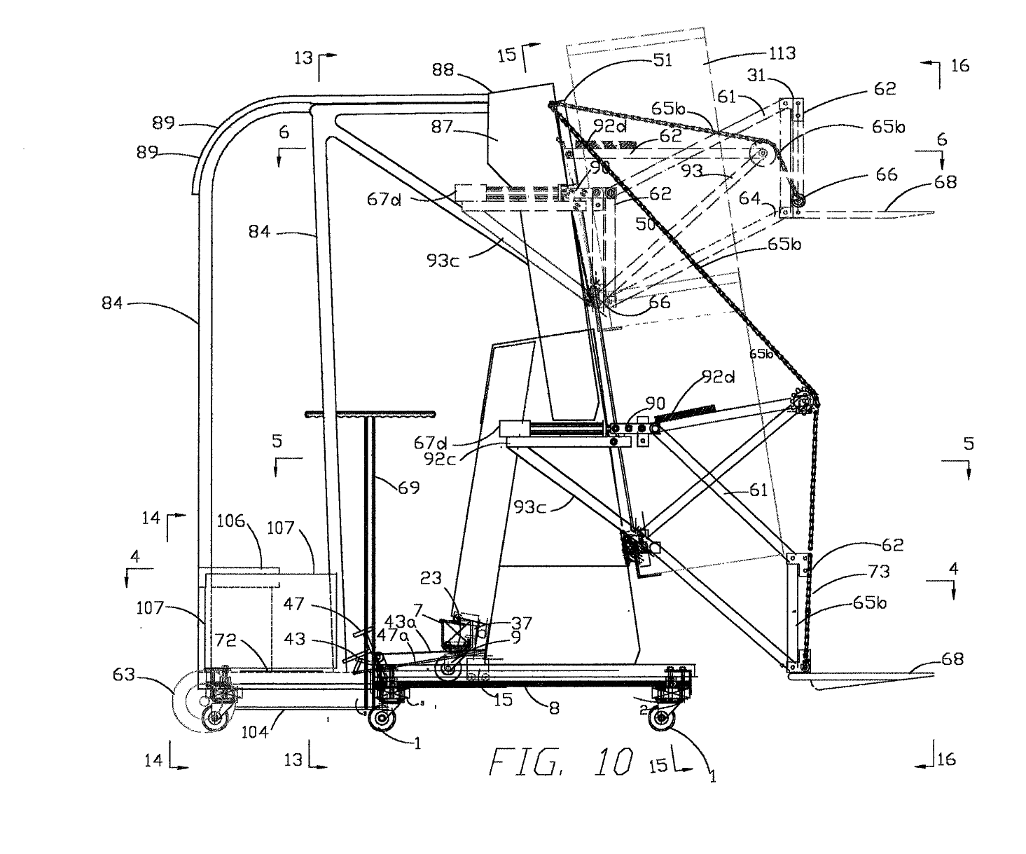

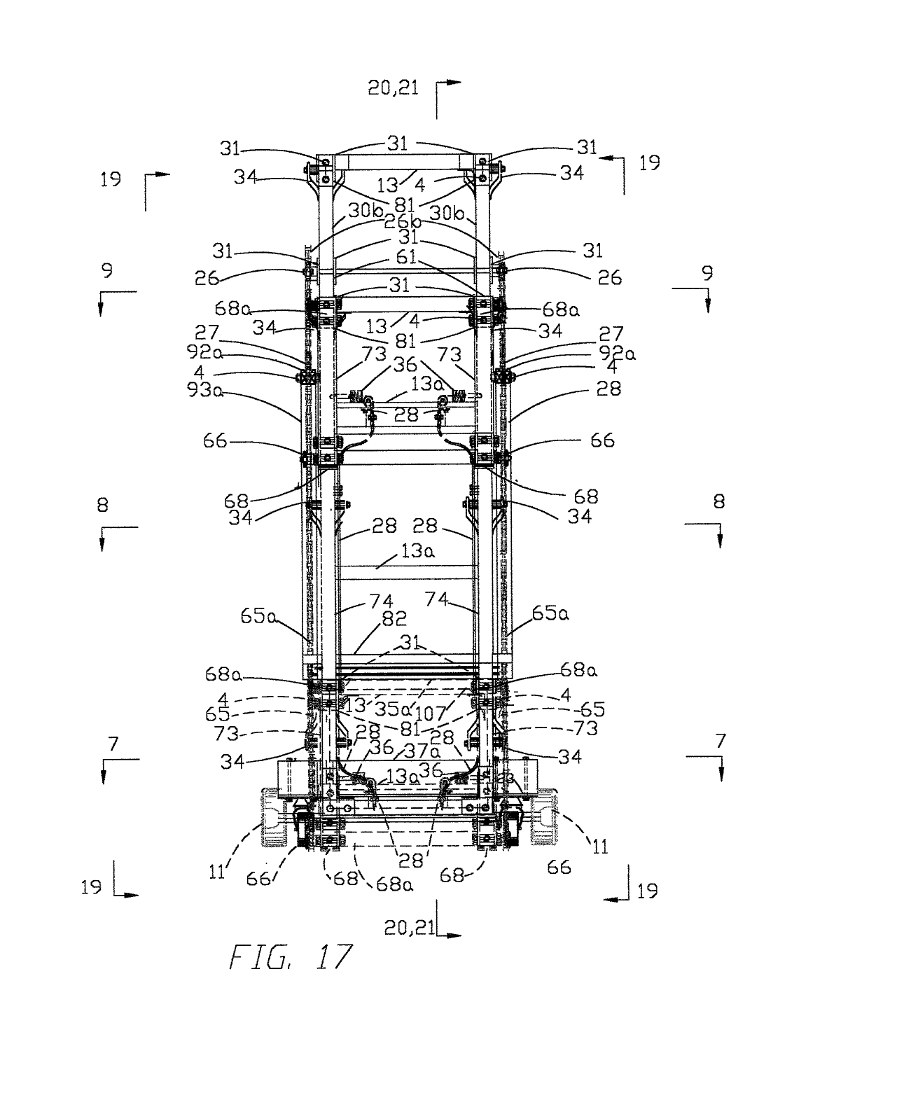

A retractable pin assembly 36 is used to hold the raised rotary mast frame 62 at selected locked heights on mast props 74 when required. The retractable pin assembly is a spring-loaded assembly that engages in slotted holes in mast frame assembly 73 which sleeves vertically along rotary mast props 74. The mast prop assembly is locked when the holes in metal tubes 73 and 74 are aligned with the engaging pin assembly which is mounted to the top of rotary lift frame cross tie 13 of the lift assembly as illustrated in FIGS. 9 and 16. The pins must be retracted before the rotary mast assembly is allowed to be lowered. The mast chains must be lifted slightly to free the retractable pins. The spring-loaded pins are operated by means of a manually operated cable assembly 28 connected to lever handle 34. See FIGS. 9, 17 and 19 for location of this chain/pin assembly. The spring loaded pins extend to lock the sleeved posts in place when lever controls on cables are released at handles and is therefore a safety measure for assuring that the load is secured on the post frame if the levers are released inadvertently.

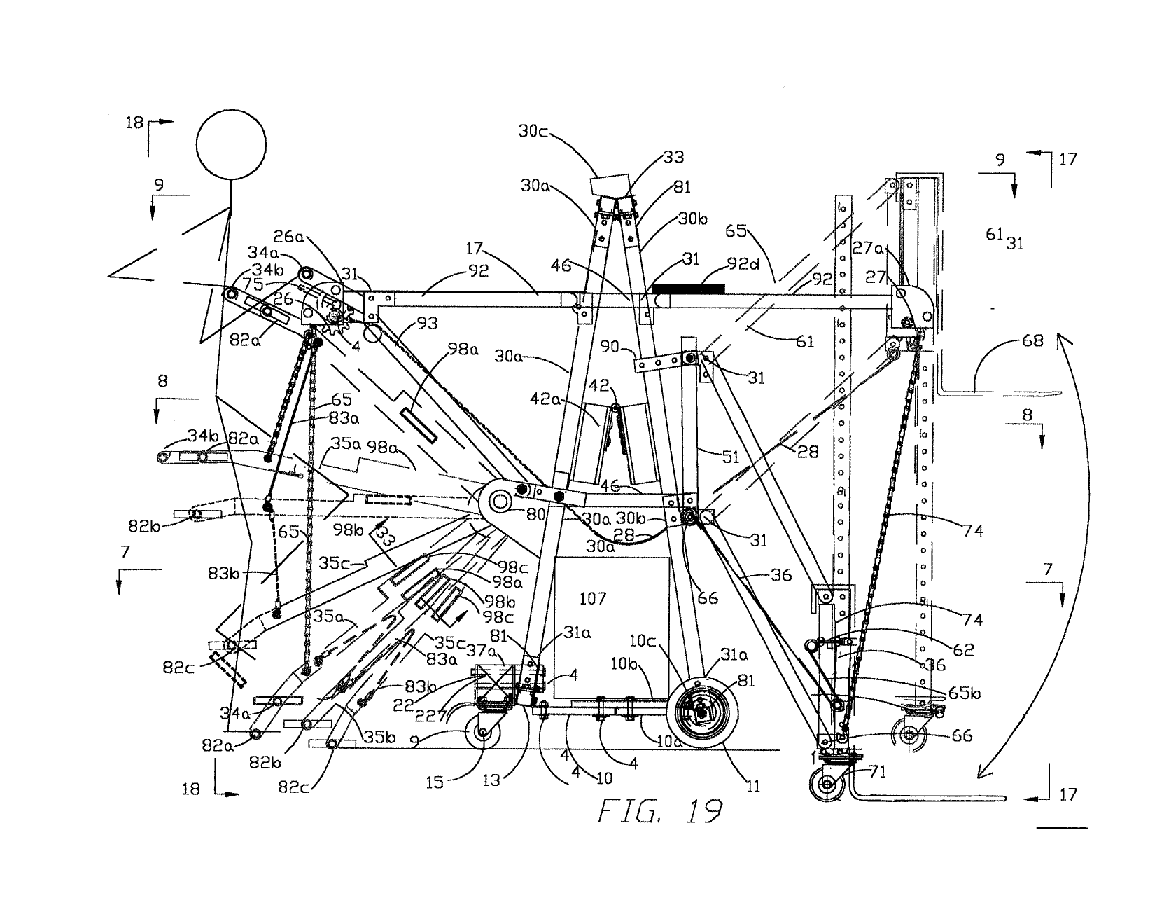

The manually operated lever chain 65 starts at a point on lever 35 at handle 34 and runs across cogwheels 26 along chain prop frame 92/93 to cogwheel 27 to a hook 66 at base of fork and tongue assembly 62/68 as illustrated in FIG. 19. The rotation of the levers controls the lifting of load fork 68. When the power operated assembly is used this fork is also rotated upward automatically when cogwheel 60 is lifted by means of hydraulic jacks 67c and 44 due to take-up in extensible mast lift chain 65b as illustrated in FIGS. 11 and 12.

The tilting of the load on fork tongue 68 on the power operated lift assembly is a means of holding or dismounting the load (see FIG. 11). The tilting is controlled by means of hydraulic jacks 67d which are mounted atop the central part of the rotary mast assembly 92/93 at both sides of the connecting base a-frame post assembly 30a/30b. The extending/retracting end of this jack is pivotally connected to the top end of the rotary lift frame mast assembly 61/62/63/64/13 at metal corner plate 31. As the jack is extended or retracted the tongue fork is rotated vertically about the diagonal opposite end of the rotary mast frame.

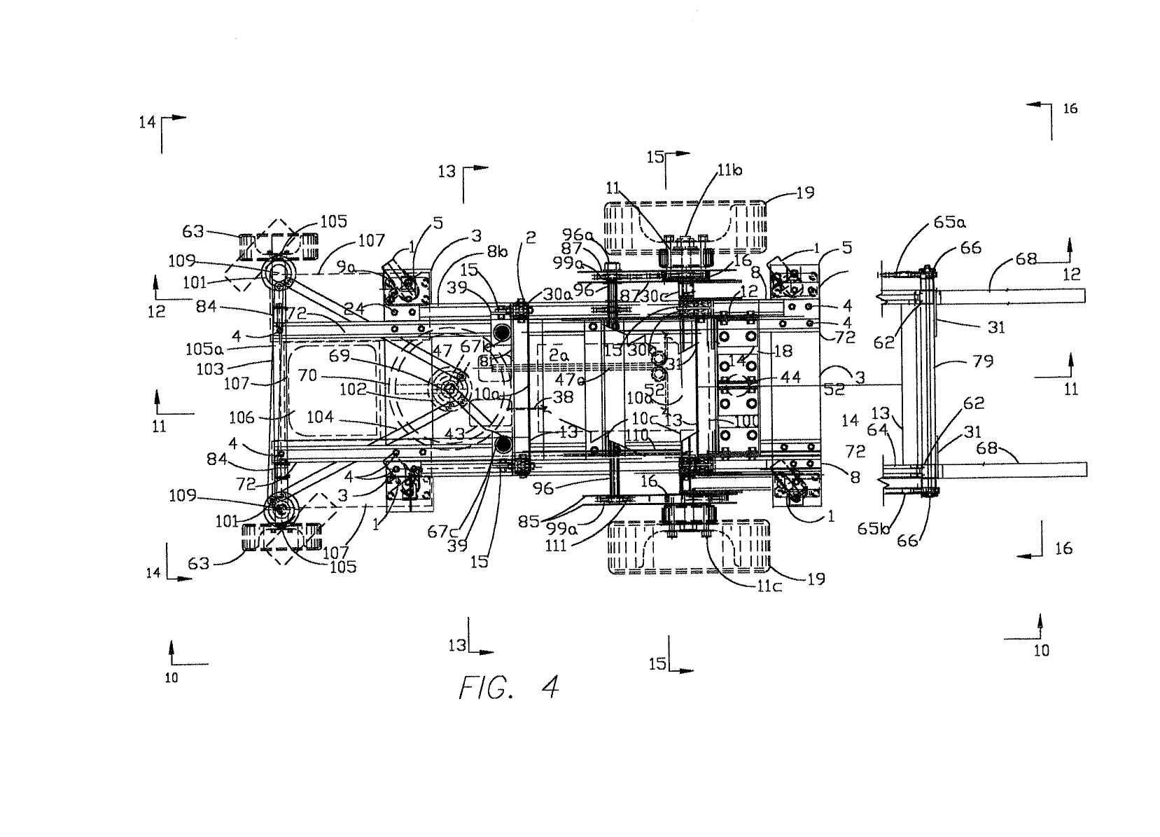

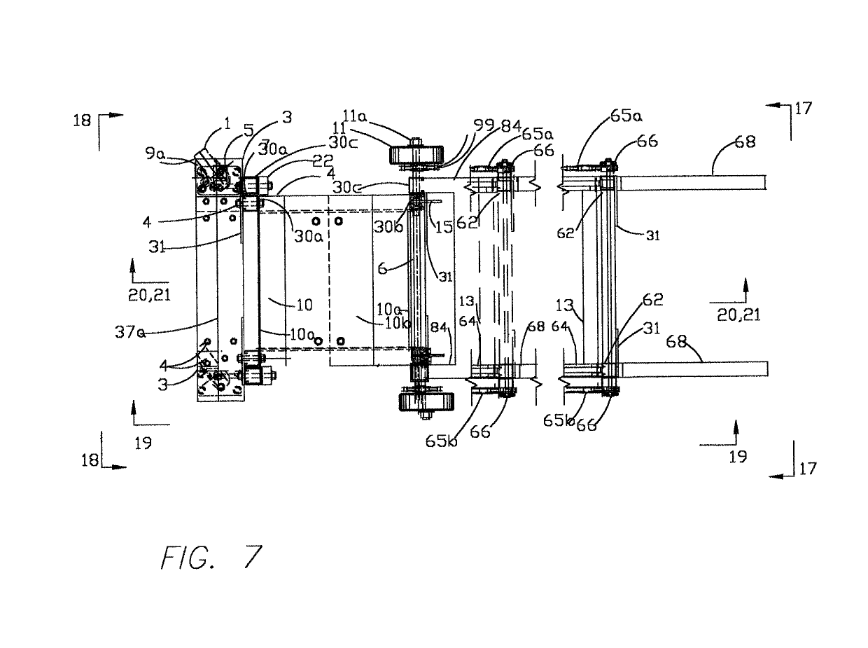

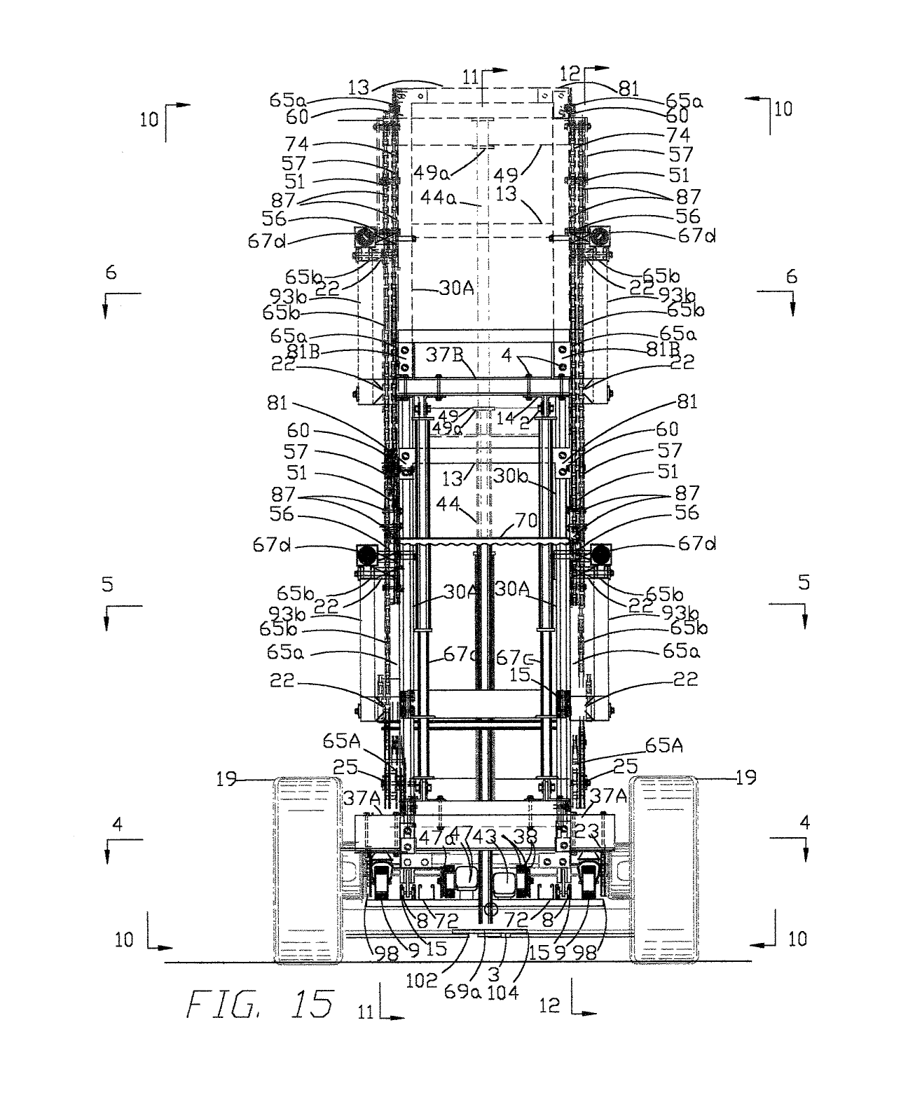

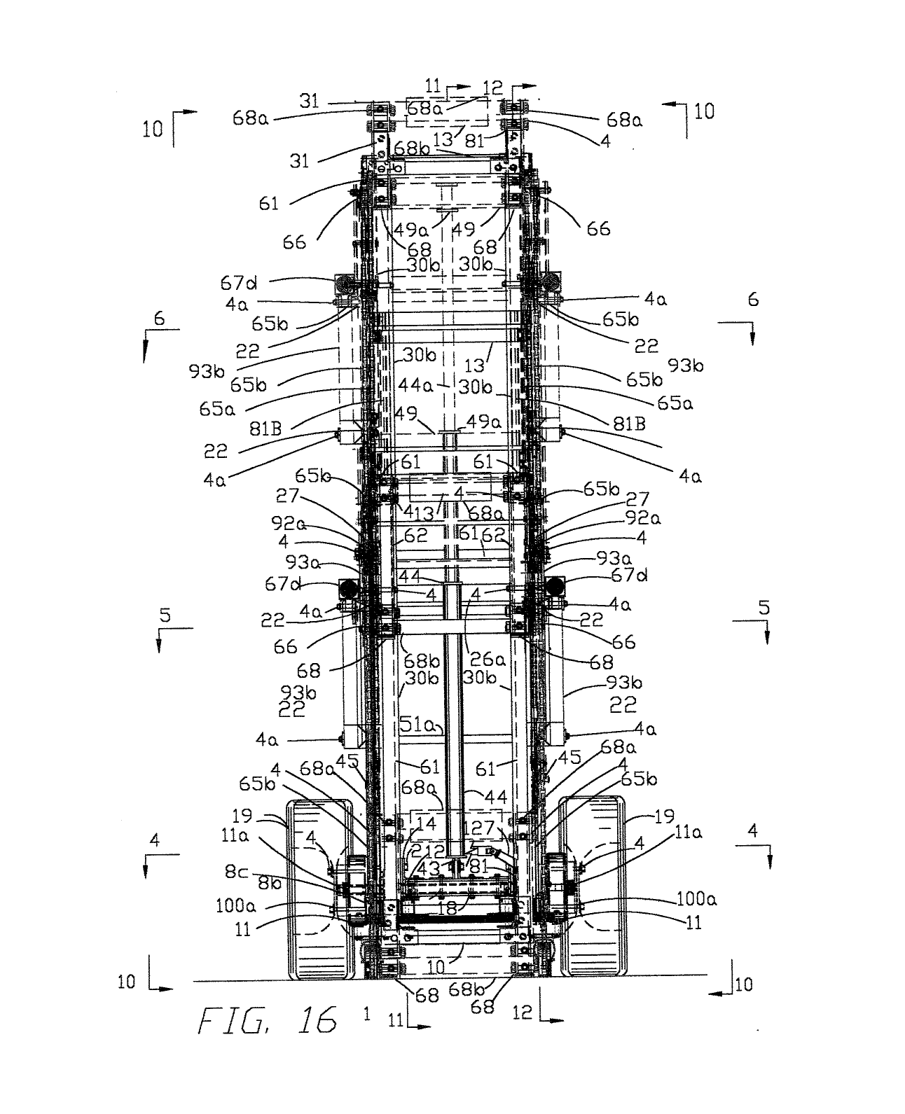

The center-of-gravity of the load on this forklift may be shifted to the center of the base carriage assembly of this lift assembly by moving the base frame assembly on trolley wheels 15 along metal channel tracks 8a mounted on the base carriage assembly. See FIGS. 4, 11 and 15. Roller wheels 9 and 11 are used to move the forklift assembly on hard and smooth surfaces when the lift assembly is not mounted atop the mobile base carriage assembly described herein. The load may also be pivoted as illustrated in FIGS. 20 and 21 to shift the center of gravity of the load. The base frame assembly may be set up as a cubicle or a-frame assembly by means of hinges 42 and straps 10c attached to the lower base frame connecting assembly 10 as illustrated in FIGS. 7, 19 and 20.

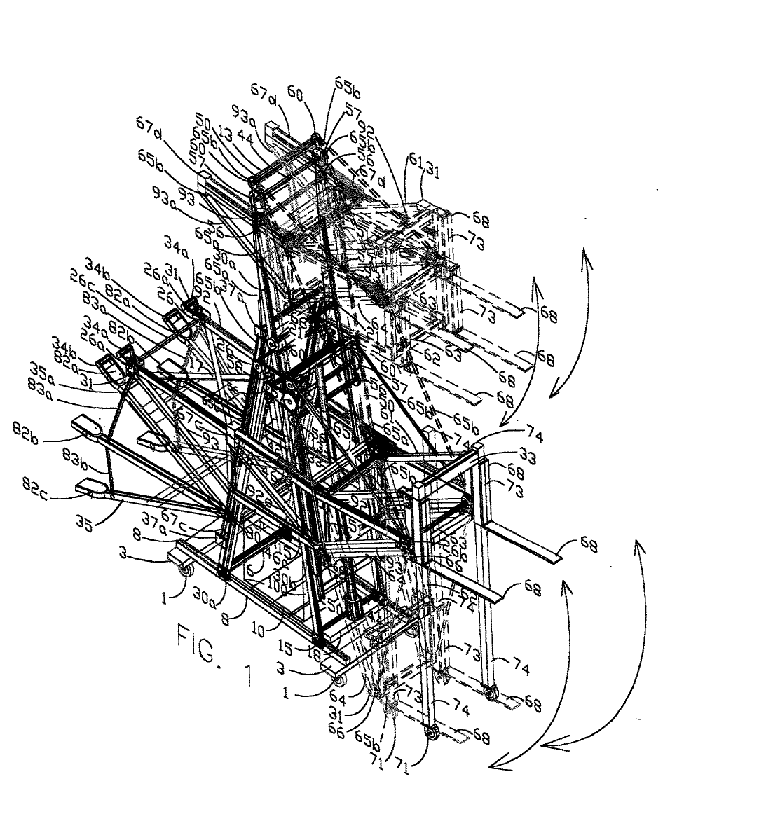

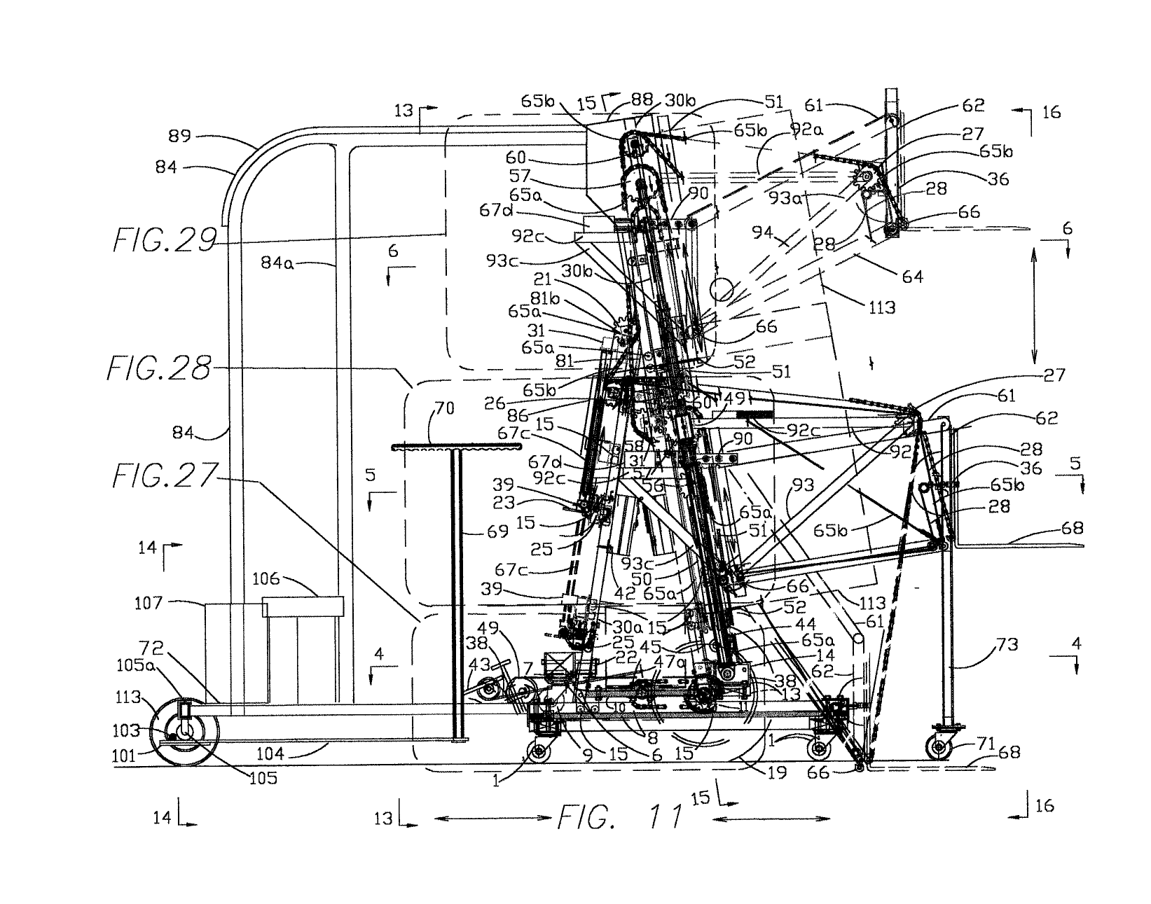

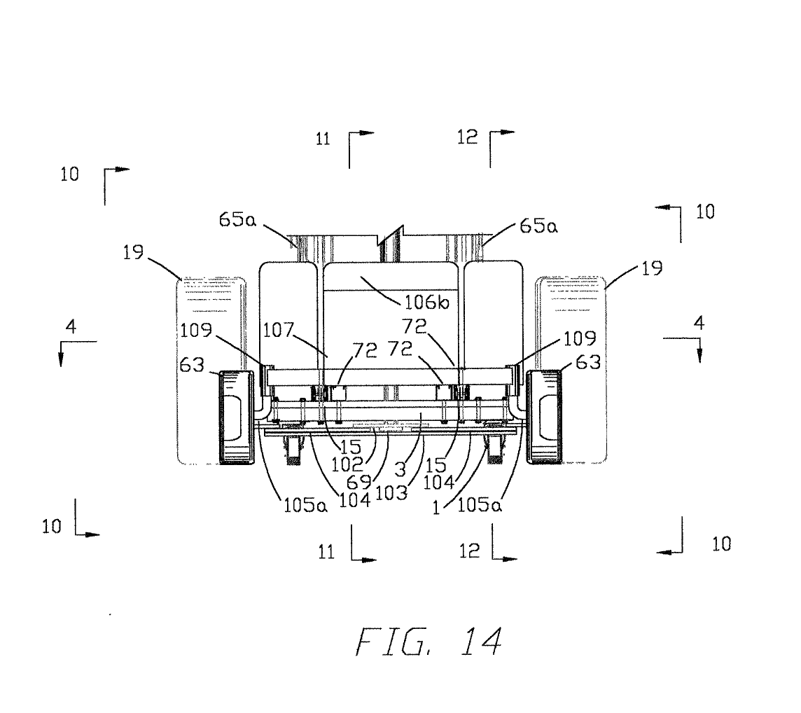

The post channels of the lift frame assembly 30a/30b are mounted on the mobile base platform assembly comprised of metal channels 8a, 72, panel 10 and cross ties 3 on both ends by means of trolley wheels 15 that roll along inside metal channel 8a. This platform assembly is mounted on axle connected front wheels 11 and rear mounted swivel wheels 1 for rolling light loads such as those carried on hand trucks. This base platform is adaptable to adding larger front wheels 19 and a rear wheel assembly 63 and 19 with a steering mechanism 69, 70, 101, 102, 103, 104 and 105 as per FIGS. 1, 4, 10 and 14.

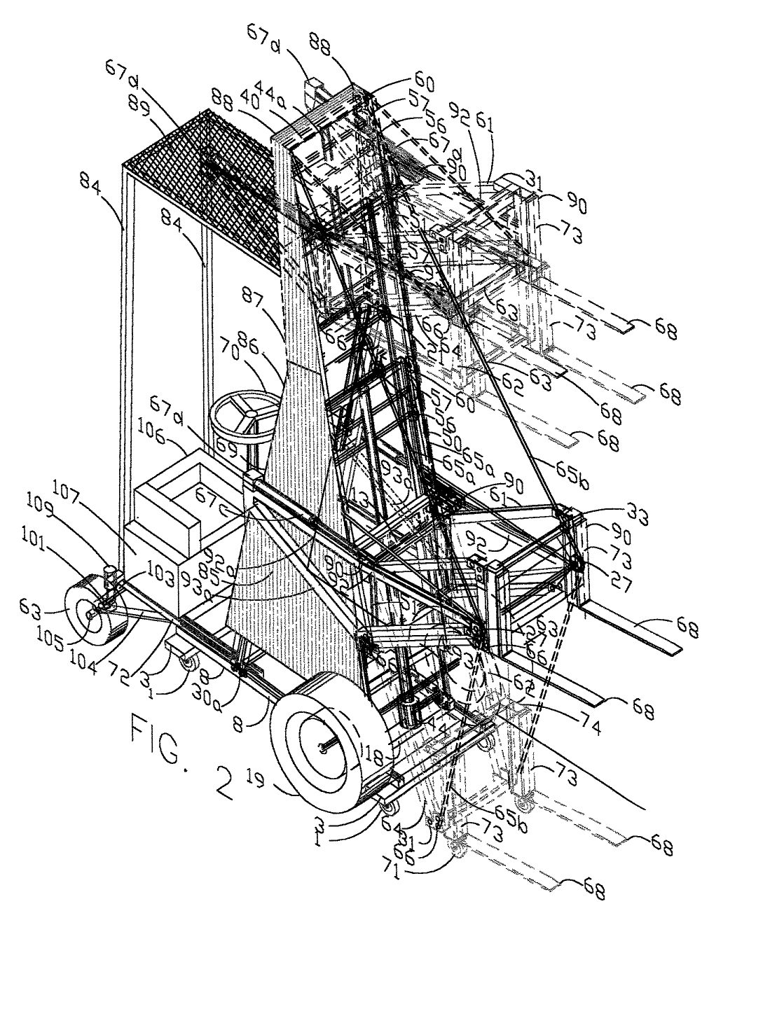

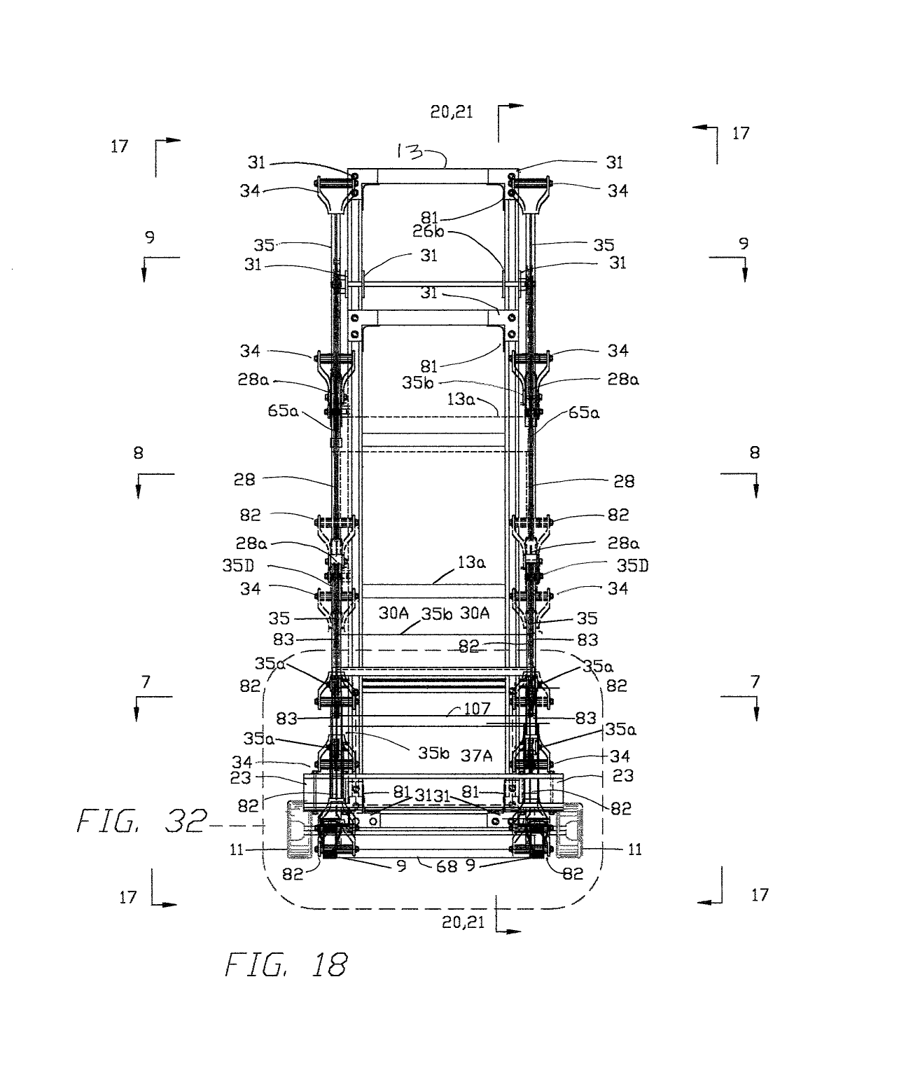

The power operated cogwheel 75, when used, is fixed directly to a motorized shaft or indirectly by means of a chain. The motor 100 would be mounted at or near the center of the base frame panel 10 as illustrated in manually operated lever assembly 34/35 with the rear chain prop frame 92/93 as illustrated in FIGS. 3, 9, 10, 18, 19, 20 and 21 is optionally mounted with connections to the central portion of this chain prop assembly when no electrical power is available and the load to be lifted does not exceed the lifters body weight. FIGS. 2, 4 and 1

1. Lift carriage swivel wheel

2. Short hex through bolt

3. Lift carriage cross tie

4. Long through bolt

4a. Long bolt welded to frame at base

5. Base frame angle

6. Lower carriage cross tie

7. Base frame swivel wheel mounting angle

8. Base frame panel

9. Base frame swivel roller wheel

10. Base frame panel assembly

10a. Pivotal base panel strap

11. Base frame roller wheel

11b. Base frame roller wheel axle

12. Hydraulic jack axle mounting bracket

13. Frame connecting channel

14. Base frame mounting angle

15. Dual axle trolley wheel

16. Brake drum

17. Diagonal brace

18. Jack base mounting plate

19. Tire

20. Single axle trolley wheel

21. Off-set chain cable wheel

22. Spacer block

23. Base frame plate

24. Base frame bracket bolt

25. Extending cogwheel at rear frame

25a. Rear cogwheel axle

26. Rear cogwheel at chain prop assembly

26a. Rear chain guide

26b. Rear cogwheel axle

27. Front cogwheel at chain prop assemble

27a. Front chain guide

27b. Front cogwheel axle

28. Set pin caliper cable

29. Gear lever handle

30a. Rear frame vertical channel

30b. Front frame vertical channel

30c. Auxillary front vertical channel

30d. Auxillary rear vertical channel

31. Corner bracket

32. Mast guide mounting bracket

33. Lift frame base cross tie

34. Lever handle

35. Pivoting lever channel

36. Mast post set pin

37a. Rear jack mounting angle

37. Rear swivel wheel mounting bar

38. Accelerator cable assembly

39. Rear jack guide

40. Upper lateral frame connecting channel

41. Middle A-frame connecting bar

42. A-frame connecting hinge

43. Accelerator pedal

44. Front mounted extensible mast jack

45. Lower front fixed cogwheel

45a. Lower front cogwheel axle

46. Upper rotary mast extension bar

47. Brake pedal

47a. Brake cable assembly

48. Upper frame cogwheel

48a. Upper axle

49. Upper extensible mast frame

50. Primary extending mast frame

51. Secondary extending mast frame

52. Mast lift angle seat

53. Secondary extending mast frame mounting bracket

54. Primary extending mast frame mounting bracket

55. Base mast trolley mounting bracket

56. Intermediate extensible mast chain cogwheel

56a. Intermediate axle

57. Upper extensible mast chain cogwheel

57a. Upper mast cogwheel axle

58. Central upper frame mast chain cogwheel

58a. Central mast cogwheel axle

59. Secondary mast frame connecting bolt

60. Upper mast chain cogwheel

60a. Upper mast axle

61. Upper rotary mast frame

62. Vertical front rotary mast frame

63. Front wheel

64. Lower rotary mast frame

65a. Extensible mast lift chain

65b. Extensible rotary mast chain

66. Mast lift hook

67a. Rotary mast hydraulic jack

67b. Mast fork tilting jack

67c. Extensible rotary mast jack

67d. Tilt jack for rotary mast fork tongue

68. Fork lift tongue

68a. Fork tongue hook mounting bracket

68b. Fork tongue connecting bar

69. Steering column

70. Steering wheel

71. Mast post swivel wheel

72. Extended base channel

73. Slotted rotary mast tube sleeve

74. Slotted rotary mast support post

75. Cable lever for spring loaded set pin at rotary frame support post assembly.

76. Drive chain

77. Horizontal rotary frame channel

78. Lever axle bracket

79. Axle bracket

80. Lever assembly pivot bracket

81. Corner plate

82. Suspended foot pedal

83. Foot pedal suspension cable

84. Base rotary frame prop

85. Lower chain cover

86. Middle chain cover

87. Upper chain cover

88. Top mast cover

89. Overhead protective grille

90. Rotary frame/fork tongue to jack connection

91. Forklift tongue mounting bracket

92a. Upper front cable brace frame

92b. Upper cable brace frame bracing bar

92c. Upper tilt jack mounting frame

92d. Upper rear cable brace frame

92e. Tilt jack frame lateral connecting bar

93a. Lower cable brace frame

93b. Lower front cable brace frame

93c. Lower tilt jack mounting frame

94. Rotary brace connecting bar

95. Hydraulic pump bracket

98. Horizontal lever brace connection

96. 99a. Secondary drive shaft cogwheel Primary drive shaft axle

97. Drive shaft connecting bracket

99b. Secondary drive shaft cogwheel axle

100. Motor housing

101. Front end cross bar

102. Stirring mechanism pivot ring

103. Stirring mechanism tie rod

104. Stirring mechanism connecting rod

105. Front wheel axle

105a. Front axle mount cross bar

106. Operator's seat

107. Counter weight/seat base

108. Pump drive cogwheel

109. Spring loaded axle pivot

110. Gear wheel drive frame

111. Drive chain

112. Universal joint/drive shaft assembly

113. Bulky load

114. Cross bracing

1. What I claim is an improvement in a hand truck with the addition of a manually operated fork lift on a detachable track assembly platform on a swivel wheeled base with a lift fork operated by use of a rotary mast which is pivoted upward about a point on the front frame of the lift apparatus by means of prop supported chain assemblies with cogwheels which are operated manually by means of levers mounted on the rear frame of the lift apparatus with minimal space take-up when loads are carried or when the lift is stored and not in use.

1a. I further claim that the manually operated hand track fork lift is further improved by securing the lift fork in a raised position by use of swivel wheel mounted sleeved posts which are punched to receive spring loaded pins which are controlled by use of hand operated cable assemblies terminating at the lever handles which when released intentionally or inadvertently allows the spring loaded set pin to engage as a security measure to hold the load on the lift fork in the raised position.

1b. further claim as a chain prop assembly which is used to maximize the length of chain at a constant length while the lever arms are rotated thereby maximizing the lift height of the rotary lift fork.

1c. I further claim as my invention a base frame track assembly along which trolley wheels roll to offset the center of gravity of the loads on the extending and rotary lift masts.

2. I further claim that this invention is also an improvement in a power operated hydraulic forklift assembly by use of a series of chains, extensible masts and rotary mast attachments operated by a series of hydraulic jacks to achieve extended reach in depth and height when the rotary frame is attached to an extendable lift mast, and as an alternative to lifting by use of a rotary frame to lift loads on a fixed mast or lift frame.

2a. I further claim an improvement in the tilting of the load on the lift fork attached to the rotary frame of the power operated lift assembly whereby the rotary frame is further operated by means of the extension an retraction of a pair of hydraulic jacks attached to the base lift frame and rotary frame as illustrated in drawings in this application.

3. I claim as an improvement in a manually operated hand truck assembly with lever, post and rotary frames components assembled by use of a series corner, angle and flat plates at connection points as illustrated in the drawings in this application which allows for the use of isolation pads at these plate connections such that various alternative dissimilar materials including wood with conventional metal gusset plates and straps at end stress points may be used to assemble lighter and more economical lift assemblies with variable lifting capacity limits, but more versatile uses with respect to handling of the lift apparatus hand truck.
